(19) United States
(12) Patent Application Publication
(10) Pub. No.: US 2009/0006192 A1
(43) Pub. Date: Jan. 1, 2009

(54) Point of Presence Sponsorship Mechanism for Digital Content Objects

(75) Inventors: Ronald Martinez, San Francisco, CA (US); Balaji Ravindran, Los Angeles, CA (US); Chris Kalaboukis, Los Gatos, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/771,223

(22) Filed: Jun. 29, 2007

(51) Int. Cl. G06Q 30/00; G06F 15/16

(52) U.S. Cl. 705/14; 709/201

(57) ABSTRACT

Particular embodiments of the present invention are related to a point-of-presence distribution and sponsorship mechanism facilitating sponsored distribution and use of digital content, ad content and revenue generation opportunities.

### TECHNICAL FIELD

The present disclosure generally relates to distribution and sponsorship of multimedia content and other digital content objects over networks.

### BACKGROUND

Interactive systems connected wide area networks, such as the Internet, have steadily evolved into vibrant mediums for social interaction and sharing of digital media. Indeed, an enormous amount of digital media generated by end users, media companies, and professional media creators is made available and shared across the Internet through web sites and uploading to various content hosting or aggregation systems and services (e.g., Flickr®, Yahoo!(r) Video, YouTube.com, etc.). End-users increasingly use or share media in a variety of on-line and interactive contexts. For example, an ever-increasing number of end-users create websites of various types, including blog pages, personalized social networking pages (such as Yahoo! 360, Facebook, or MySpace), that utilize digital media content, such as images, video, and music. Furthermore, digital media content is often found posted to online groups or forums, or other purpose-built sites, such as for small businesses, clubs, and special interest groups.

These two dynamics are closely related in that online media available on the Internet is often re-used or included in the pages of web sites, social network sites, on-line forums, or other systems. For example, a user may create a blog about a topic of personal interest—e.g., beagles. When posting to the blog (creating a short text item), the user may include an image of a beagle that illustrates the point or subject of the post (e.g., beagle ear length). To locate an image, the user may access an image search engine and find a suitable image. To add the image to the blog post, the user may download that image to a hard drive or other data store, and then upload the image to the blog hosting site. Alternatively, if technically adept, the user may add HTML code to the blog post that will display the image in the post, causing the image to be loaded from its original location when the blog is viewed. Video and audio content may also be added to blogs or other network addressable resources, such as personal pages, in a similar manner.

The rise of the Internet has created a universal distribution mechanism for any content or experience that can be digitized and distributed as data packets over distributed telecommunications networks. Online advertising has proven to be a lucrative and effective distribution funding mechanism for such content because advertisers are willing to pay for the distribution (and often development) of content desired by users to accompany their business or brand advertisement. As the number of users and computers on this global network continue to grow, the numbers of creators and publishers of content is exploding, and yet the mechanisms for experiencing and licensing or redistributing the content continue to be separate. In fact, it is nearly always necessary to engage in offline activities such as phone negotiations, contract executions etc. in order for an advertiser to license or sponsor a specific piece of content at the point of experiencing it.

In current and prior forms of media, advertisers are able to order advertising against media selected prospectively. In effect, a bet is placed in advance of knowledge about the initial or continued popularity of the media. Only after such media (such as a television show) had proven its popularity through audience share statistics, would advertisers be able to more effectively calculate the potential value of such advertising, and hence what they were willing to pay for it. Online advertising systems associating ads with content improved the situation somewhat, as such systems could determine which of a relevant set of ads with standing orders might best be displayed alongside content. Auction-style pricing models enabled would be advertisers to set a bid, such that their bid would be evaluated alongside others when the media is displayed, and the one with the highest bid (possibly along with other factors, such as past effectiveness of the ad relative to others) would be selected in real-tune and displayed. In an interactive medium where millions of pieces of content newly appear on an ongoing, continual basis, and where some content has a rapid (and frequently short-lived) rise in popularity, there has not been a way for an advertiser to efficiently and easily sponsor the media in the context of its popularity, thereby optimizing ad spend with the same immediacy as the appearance of popular content.

### DESCRIPTION OF THE DRAWINGS

FIG. 1 illustrates an example network environment in which particular implementations may operate.

FIG. 2 illustrates an example method according to one possible implementation of the invention.

FIG. 3 illustrates an example web page interface.

FIG. 4 illustrates an example web page interface including hypertext links configured in accordance with a particular implementation of the invention.

FIG. 5A illustrates an example web page interface including a distribution interface in a pop-up window.

FIGS. 5B thru 5D provide example methods directed to generating content embedding code in response to activation of distribution and sponsorship links.

FIGS. 5E thru 5H illustrate example point-of-present sponsorship interfaces.

FIGS. 6A thru 6G set forth example content-embedding code and code sections.

FIG. 7A illustrates an example blog posting interface.

FIG. 7B illustrates an example user interface including embedded content and benefit attachment links.

FIGS. 8A thru 8C provide example methods, according to particular implementations, directed to generating content-embedding code.

FIG. 9 illustrates an example method directed to processing requests for embedded content objects.

FIG. 10 illustrates an example web page including an advertisement.

FIG. 11A is a schematic diagram illustrating an example computing system architecture that may be used to implement one or more of physical servers.

FIG. 11B is a schematic diagram illustrating an example computing system architecture that may be used to implement one or more of client systems.

FIG. 12 illustrates an example method directed to processing requests involving ad links according to particular implementations.

### DESCRIPTION OF PREFERRED EMBODIMENT(S)

### A. Overview

Particular embodiments of the present invention are related to a point-of-presence distribution and sponsorship system for digital content objects. Systems and methods described herein enable viewers of a media object, such as a picture or video, to effect sponsorship of that media object. Such media may be viewable on any network-connected device, and after identifying him/herself to the system, a viewer can order any of a number of advertisements to be associated with the media object wherever it is displayed (for example, on an ad hoc network of websites) and also indicate an offer for such sponsorship, or alternatively accept a pre-set price for such sponsorship. In a particular implementation, the present invention also provides for a viral content and ad distribution mechanism.

In some particular implementations, the present invention further relates to digital media benefit attachment mechanism for generating or attaching revenue rights and other benefits to one or more entities associated with media distributed over computer networks. Particular implementations can involve content aggregation and distribution systems, advertising systems, and social media systems in a manner that promotes release and sharing of multimedia content over networks. In one implementation, the present invention can be configured to include a viral component that facilitates distribution of digital content objects and one or more ads that are displayed in connection with the digital content objects. In some implementations, the present invention may also provide for revenue sharing between two or more entities in the distribution chain of a given digital content object.

The present invention can be implemented in a variety of manners. In some particular implementations, one or more of the following events or processes can occur. In some implementations, a content owner may upload a digital content object (or specify a data locator of the digital content object indicating where the content object is hosted) to a network addressable system, such as a media aggregation site (an example being Yahoo!(r)'s Flickr® photo sharing system). The content owner may configure one or more tags, and provide identifying information of the content owner. The content, owner may also configure one or more parameters directed to further distribution and/or revenue sharing associated with the digital content object. The network addressable system stores the tags and related information in association with the uploaded content object. In a particular implementation, the network addressable system may generate an object instance identifier and corresponding data record including the information identified above. The network addressable system may also generate content embedding code including a distribution code section and provide the content embedding code to the user. The user may then use the content embedding code in connection with the digital content object—e.g., to embed or otherwise make the digital content object available to other users over a network. Thereafter, a second user may view the content object and, activating a sponsor control associated with the content, object, initiate a workflow directed to sponsoring the content object.

In some implementations, content-embedding code is source code (such as HyperText Markup Language (HTML) code), or other machine-readable instructions, that a user may insert into an underlying data object (such as an HTML page). The content-embedding code, for example, can be inserted into an interface of an HTML editing application that creates or edits HTML pages, which can be published to a web server. The HTML editing application can be a stand-alone application executed on a host, or a network application hosted on a remote server, such as a blog server, personal page, etc. The content-embedding code, when accessed and executed in connection with the underlying data object, causes a processor to retrieve or otherwise access the content, and present one or more hyperlinks in association with the content. In some implementations, the content embedding code may include hyperlinks that, when activated, are operative to generate revenue or some other benefit to one or more entities associated with distribution, hosting or creation of the content. Particular implementations provide for different hyperlink types that can be used independently or in combination, such as sponsor links, ad links, search links, and content sharing links. In one implementation, revenue generated by activation of one or more of these links (such as links to sponsored ads or content in search results) can be shared between one or more of the following entities content owners, content uploaders, content embedding entities, network application hosting service providers, content hosting service providers, search system providers, advertising system providers, or others. In particular implementations, one of the hyperlinks is a distribution hyperlink that, when activated, initiates a workflow wherein content embedding code is generated and provided to subsequent users who have accessed the digital content object and desire to re-use or re-distribute the digital content object. As discussed below, a variety of implementations are possible.

Particular implementations of the invention can be configured to achieve a variety of revenue models and benefit attachment schemes. Particular implementations of the invention allow for revenue sharing and distribution schemes involving distribution of digital media beyond traditional compensation schemes, where a content owner or provider is essentially compensated based on advertising displayed in connection with the content. Particular implementations of the invention provide novel revenue models that allow a vast array of social media systems, such as content aggregation sites and social network sites, to monetize one or more aspects of their operations hi manners not currently realized. Particular implementations of the invention provide revenue models and compensation mechanism that provide added inducements to content creators and rights owners to release content into social media distribution networks. Other implementations of the invention facilitate the sponsorship, use and redistribution of digital media content among a plurality of users.

By providing incentives and facilitating mechanisms, such as content-embedding code, the process of finding and using media content can be simplified, resulting in improved work product, greater authorized use of content, and more revenues to one or more participating entities. The distribution mechanisms described herein can be configured to provide a variety of advantages or features. In some implementations, the distribution mechanisms described herein provide ways for content hosting systems, such as media aggregation sites, to be compensated when the media is used on any of a wide range of other sites. In addition, in some implementations, the distribution mechanisms described herein may be configured to provide incentives for users to embed content in their own underlying content. In some particular implementations, the distribution mechanisms described herein can be configured to provide incentives to content owners to upload content. In some implementations, the distribution mechanism may provide incentives for media companies and individuals to make otherwise tightly controlled content available for use in derivative works such as social network pages or blogs, etc.

In the following description, specific details are set forth in order to provide a thorough understanding of particular implementations of the present invention. Other implementations of the invention may be practiced without some or all of specific details set forth below. In some instances, well known, structures and/or processes have not been described in detail so that the present invention is not unnecessarily obscured.

A.1. Example Network Environment

Particular implementations of the invention operate in a wide area network environment, such as the Internet, including multiple network addressable systems. Network cloud 60 generally represents one or more interconnected networks, over which the systems and hosts described herein can communicate. Network cloud 60 may include packet-based wide area networks (such as the Internet), private networks, wireless networks, satellite networks, cellular networks, paging networks, and the like.

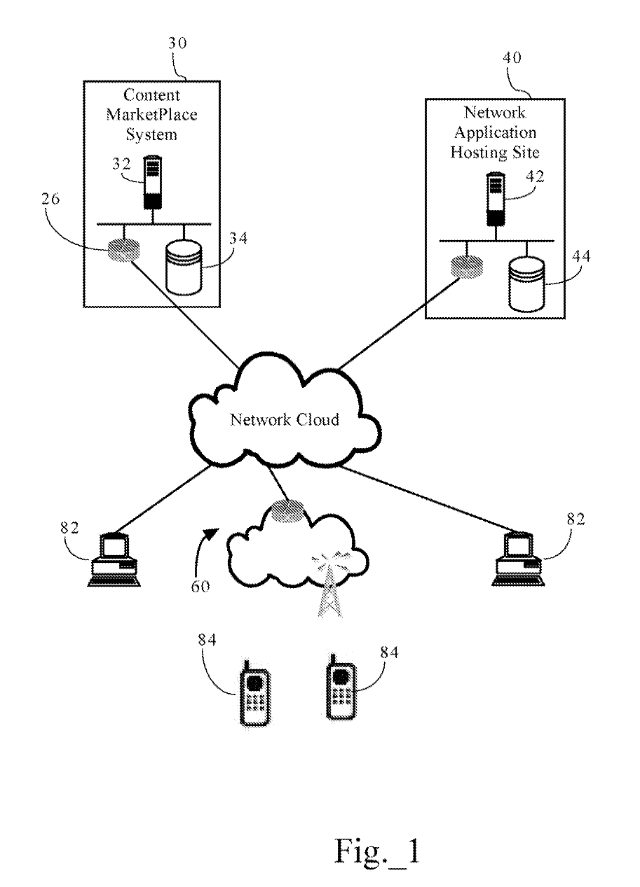

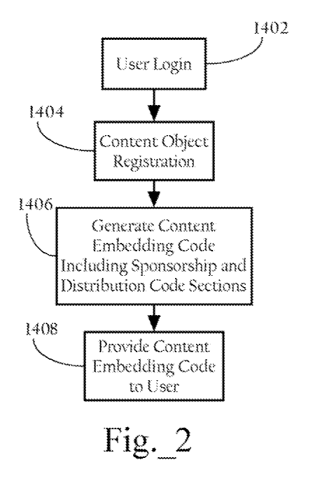

As FIG. 1 illustrates, a particular implementation of the invention can operate in a network environment comprising content marketplace system 30, and network application hosting site 40. Although FIG. 1 illustrates the foregoing systems as separate systems, the functionality represented by each system may be combined into other systems, and/or be operated by the same administrative domain. Furthermore, the functionality represented by each depicted system may be further separated. Still further, implementations of the invention may operate in network environments that include multiples of one or more of the individual systems and sites disclosed herein. In addition, other implementations may operate in network environments where one or more of the systems described herein have been omitted. Client nodes 82, 84 are operably connected to the network environment via a network service provider or any other suitable means.

A.1.a. Content Marketplace System

Content marketplace system 30, in one particular implementation, is a network addressable resource that hosts functionality directed to the content distribution and sponsorship mechanisms described herein. Content marketplace system 30 stores content uploaded by one or more users, and allows other users to sponsor the content. Content marketplace system 30 may also host other functionality, such as monitoring applications that track clickstream activity, content usage, revenue generation and the like. In the implementation shown, content marketplace system 30 comprises one or more physical servers 32 and one or more data stores 34 operably connected to network 60 via router 26. Physical servers 32 host functionality directed to the content distribution and sponsorship mechanisms described herein. In one implementation, the functionality hosted by the one or more physical servers may include web or HTTP servers, FTP servers, and the like. One or more of the physical servers 32 may also host functionality that supports other process and message flows, as described below.

For example, data store 34 may store user account information, corresponding to one or more of the entities described below, including user identifiers, passwords, addresses, preferences, financial account information, as well as pointers to uploaded content. The one or more physical servers 32 host functionality that allows users to upload and retrieve content. In some implementations, one or more of the physical sewers 32 may include functionality that generates content-embedding code that facilitates operations that assist content embedding entities in embedding available content (such as videos, images, etc.) into underlying resources (e.g., blogs, personal pages, and other documents).

Data store 34 may also store content as digital content data objects. A content data object or content object, in particular implementations, is an individual item of digital information typically stored or embodied in a data file or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc. Structurally, data store 34 connotes a large class of data storage and management systems. Data store 34 may be implemented by any suitable physical system including components, such as database servers, mass storage media, media library systems, and the like.

A variety of implementations are possible. For example, while FIG. 1 illustrates content marketplace system 30 as a single integrated system, the functionality described herein may be distributed across separate systems. Furthermore, content marketplace system 30 can be configured to operate in connection with one or more separate content hosting sites, as well as hosting uploading content itself.

A.1.b. Network Application Hosting Site

Network application hosting site 40 is a network addressable system that hosts a network application accessible to one or more users over a computer network. The network application may be an informational web site where users request and receive identified web pages and other content over the computer network. The network application may also be an on-line forum or blogging application where users may submit or otherwise configure content for display to other users. The network application may also be a social network application allowing users to configure and maintain personal web pages. The network application may also be a content distribution application, such as Yahoo! Music Engine®, Apple® iTunes®, podcasting sewers, that displays available content, and transmits content to users. As FIG. 1A illustrates, network application hosting site 40 may comprise one or more physical servers 42 and a data store 44.

A.1.c. Client Nodes

Client node is a computer or computing device m eluding functionality for communicating over a computer network. A client node can be a desktop computer 82, laptop computer, as well as a mobile device 84, such as cellular telephones, personal digital assistants. A client node may execute one or more client applications (such as a web browser, video player, audio player, etc.) to access and view or experience content over a computer network. In particular implementations, the client applications allow users to enter addresses of specific network resources to be retrieved. These addresses can be Uniform Resource Locators, or URLs. In addition, once a page or other resource has been retrieved, the client applications may provide access to other pages or records when the user “clicks” on hyperlinks to other resources. In some implementations, such hyperlinks are located within the web pages and provide an automated way for the user to enter the URL of another page and to retrieve that page. The pages or resources can be data records including as content plain textual information, or more complex digitally encoded multimedia content, such as software programs or other code objects, graphics, images, audio signals, videos, and so forth.

A.2. Example Protocol Environment

The networked systems described herein can communicate over the network 60 using any suitable communications protocols. For example, client nodes 82, as well as various servers of the systems described herein, may include Transport Control Protocol/Internet Protocol TCP/IP networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used. In addition, a server in one interaction context may be a client in another interaction context. Still further, in particular implementations, the information transmitted between hosts may be formatted as HyperText Markup Language (HTML) documents. Other structured document languages or formats can be used, such as XML, and the like.

In some client-server protocols, such as the use of HTML over HTTP, a server generally transmits a response to a request from a client. The response may comprise one or more data objects. For example, the response may comprise a first data object, followed, by subsequently transmitted data objects. In one implementation, for example, a client request may cause a server to respond with a first data object, such as an HTML page, which itself refers to other data objects. A client application, such as a browser, will request these additional data objects as it parses or otherwise processes the first data object.

Mobile client nodes 84 may use other communications protocols and data formats. For example, mobile client nodes 84, in some implementations, may include Wireless Application Protocol (WAP) functionality and a WAP browser. The use of other wireless or mobile device protocol suites are also possible, such as NTT DoCoMo's i-mode wireless network service protocol suites. In addition, the network environment may also include protocol translation gateways, proxies or other systems to allow mobile client nodes 84, for example, to access other network protocol environments. For example, a user may use a mobile client node 84 to capture an image and upload the image over the carrier network to a content site connected to the Internet.

Still further, in some implementations described below, the use of redirection messages is described. In particular implementations, redirection generally refers to transmitting a message from a server to a client application, for example, that causes the client application to access another server or resource without intervention or action by the end-user. Redirection can be accomplished in a number of different ways. For example, in connection with HTTP, redirection messages can be implemented using refresh meta tags, such as

<html><head>
<meta http-equiv=“refresh” content=“0; url=http://www.yahoo.com/”>.

In addition, redirection messages can be implemented using HTTP refresh headers.
HTTP/1.1 200 ok
Refresh: 0; url=http://www.yahoo.com/
Content-type: text/html
Content-length; 78
Follow <a href=“http://www.yahoo.com/”>link</a>.
   Redirection can also be accomplished by transmitting an HTML page including JavaScript code operative to accomplish redirection. Other suitable redirection methods can be used for other protocol environments.

A.2. Example Computing System Architectures

The client and sewer host systems described herein can be implemented in a wide array of computing systems and architectures. The following describes example computing architectures for didactic, rather than limiting, purposes.

A.2.a. Example Server System Architecture

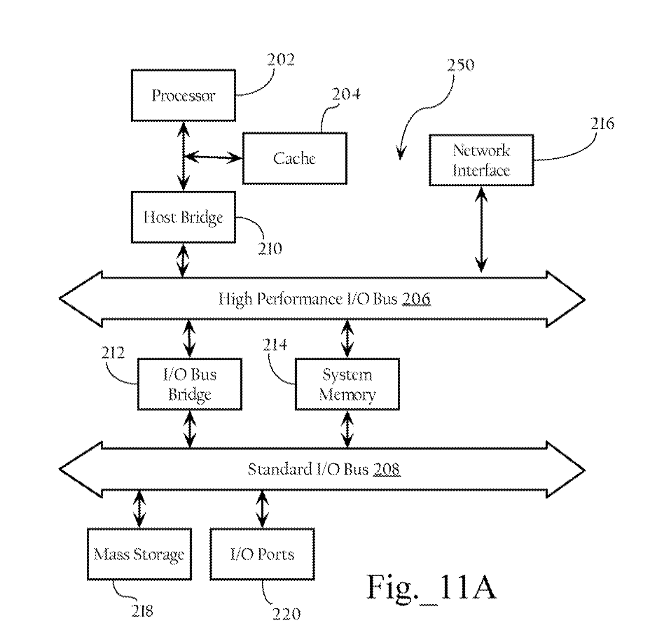

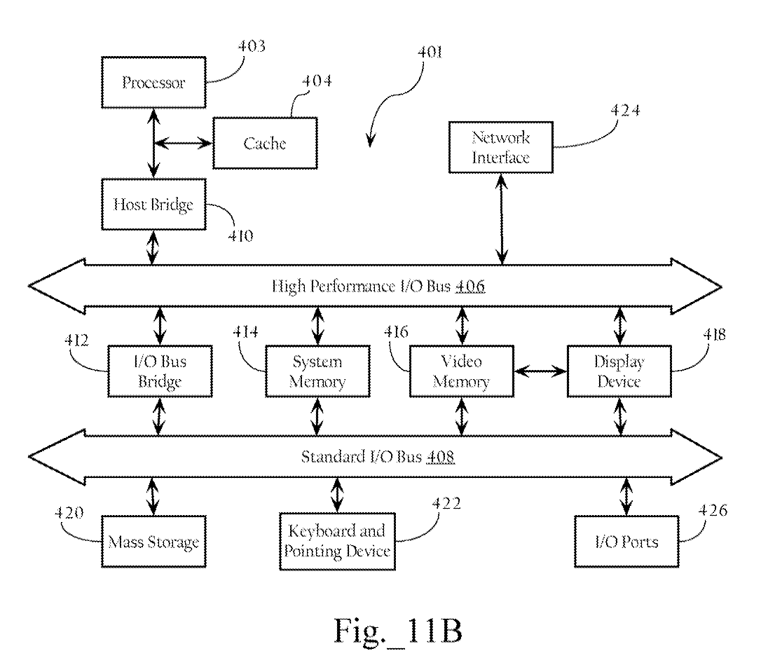

FIG. 11A illustrates an example computing system architecture, which may be used to implement a physical server. In one embodiment, hardware system 200 comprises a processor 202, a cache memory 204, and one or more software applications and drivers directed to the functions described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218, and I/O ports 220 couple to bus 208. Hardware system 200 may optionally include a keyboard and pointing device, and a display device (not shown) coupled to bus 208. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the location server 22, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain embodiments of the present invention may not require nor include all of the above components. For example, the peripheral devices shown coupled to standard I/O bus 208 may couple to high performance I/O bus 206. In addition, in some embodiments only a single bus may exist, with the components of hardware system 200 being coupled to the single bus. Furthermore, hardware system 200 may include additional components, such as additional processors, storage devices, or memories.

As discussed below, in one implementation, the operations of one or more of the physical servers described herein are implemented as a series of software routines run by hardware system 200. These software routines comprise a plurality or series of instructions to be executed by a processor in a hardware system, such as processor 202. Initially, the series of instructions may be stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interlace between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like. Of course, other implementations are possible. For example, the server functionalities described herein may be implemented by a plurality of server blades communicating over a backplane.

A.2.b. Example Client System Architectures

FIG. 11B illustrates an example hardware system 401, which may be used to implement a client node. In one embodiment, hardware system 401 includes a processor 403 and a cache memory 404 coupled to each other as shown. Additionally, hardware system 401 includes a high performance input/output (I/O) bus 406 and a standard I/O bus 408. A host bridge 410 couples processor 403 to high performance I/O bus 406, whereas an I/O bus bridge 412 couples the two buses 406 and 408 to each other. Hardware system 401 also includes a wireless network interface 424, a system, memory 414, and a video memory 416 couple to bus 406. In turn, a display device 418 couples to video memory 416. A mass storage 420, a keyboard and pointing device 422, and I/O ports 426 couple to bus 408. Collectively, these elements are intended to represent a broad category of computer hardware systems, including but not limited to general purpose computer systems based on the Pentium® processor manufactured by Intel Corporation of Santa Clara, Calif., as well as any other suitable processor.

The remaining elements of hardware system 401 are described below. In particular, network interface 424 provides communication between hardware system 401 and any of a wide range of wireline (e.g., Ethernet, etc.) or wireless networks, such as a WLAN (i.e., IEEE 802.11), WiMax (i.e., IEEE 802.16), Cellular (e.g., GSMA), etc. Mass storage 420 provides permanent storage for the data and programming instructions to perform the above described functions implemented in the system controller, whereas system memory 414 (e.g., DRAM) is used to provide temporary storage for the data and programming instructions when executed by processor 403. I/O ports 426 are one or more serial and/or parallel communication ports that provide communication between additional peripheral devices, which may couple to hardware system 401.

Hardware system 401 may include a variety of system architectures; and various components of hardware system 401 may be rearranged. For example, cache 404 may be on-chip with processor 403. Alternatively, cache 404 and processor 402 may be packed together as a “processor module,” with processor 403 being referred to as the “processor core.” Furthermore, certain embodiments of the present invention may not require nor include all of the above components. For example, the peripheral devices shown coupled to standard I/O bus 408 may couple to high performance I/O bus 406. In addition, in some embodiments only a single bus may exist, with the components of hardware system 401 being coupled to the single bus. Furthermore, hardware system 401 may include additional components, such as additional processors, storage devices, or memories.

In one embodiment, the operations of client-side functionality are implemented as a series of software routines run by hardware system 401. These software routines may comprise a plurality or series of instructions to be executed by a processor in a hardware system, such as processor 403. Initially, the series of instructions may be stored on a storage device, such as mass storage 420. However, the series of instructions can be stored on any suitable storage medium, such as a diskette, CD-ROM, ROM, etc. Furthermore, the series of instructions need not be stored locally, and could be received from a remote storage device, such as a server on a network, via network/communication interface 424. The instructions are copied from the storage device, such as mass storage 420, into memory 414 and then accessed and executed by processor 403. In some implementations, one or more aspects of the instructions may be implemented in hardware or firmware.

While FIG. 11B illustrates, for didactic purposes, the hardware architecture of a client according to one embodiment of the present invention, the client may, however, be implemented on a wide variety of computer system architectures, such as special purpose, hand held or portable devices, Personal Digital Assistants (e.g., converged devices which support WLAN data+voice), Laptop computers, hand-held phones, and the like. Still further, embodiments of the invention can operate in connection with other wireline hosts system, such as a desktop-based IP phone, and a laptop or desktop computer with an Ethernet Network Interface Controller (NIC).

An operating system manages and controls the operation of hardware system 400, including the input and output of data to and from software applications (not shown). The operating system provides an interface, such as a graphical user interface (GUI), between the user and the software applications being executed on the system. According to one embodiment of the present, invention, the operating system is the Windows® 95/98/NT/XP operating system and/or Windows® CE (WinCE) operating system, available from Microsoft Corporation of Redmond, Wash. However, the present invention may be used with other operating systems, such as the Apple Macintosh Operating System, available from Apple Computer Inc. of Cupertino, Calif., UNIX operating systems, LINUX operating systems, Symbian operating systems, and the like.

A.3. Example Participant Roles

Particular embodiments of the present invention can involve multiple entities, each assuming one or more roles. For example, in one implementation, the content, distribution and sponsorship mechanisms described herein may operate in connection with content owners, content uploaders, content embedding entities, network application hosting entities, content sponsors, and content consumers or end-users. In particular implementations, a given entity may assume more than one of these roles concurrently. An entity may be any suitable entity, such as an individual, a corporation, a partnership, a joint venture, and combinations of the foregoing. Particular implementations of the invention may operate to provide a benefit to one or more of the entities described herein based on dissemination of uploaded content over the network environment. In particular implementations, the benefit provided to one or more entities may be a monetary benefit, such as a share of revenues resulting from activation of an ad link or other control made available in connection with the content. The benefit may also be points in an account that may be redeemed for awards, such as travel and merchandize. In some implementations, the benefits provided to one or more entities may differ. For example, for a given link activation, one entity may receive a monetary benefit, while another may receive redeemable points or credits.

A content owner is an entity, such as an author or other content creator, that owns or purports to own the legal and/or beneficial rights to a given item of content. A content owner may have acquired rights in a given content item through creation of the content, or a purchase or other acquisition. Such rights may include copyrights, licenses, and/or contractual rights. In some implementations, a content, owner may be compensated as a result of use of a given content item by a content embedding entity. A content uploader is an entity that uploads a given item of content to a remote system, such as content marketplace system 30. As to a given content item, content owner may be the same entity as a content uploader, or a different entity.

A content embedding entity is an entity that uses a content item, such as by embedding the content in other underlying digital content accessible over a network, such as a blog or on-line forum post, a web page, or other network accessible content. In some implementations, a content embedding entity may be compensated as a result of third party activity related to the content that has been embedded. In some implementations, the content owner may access content marketplace system 30 to obtain content embedding code. In some implementations, multiple content embedding entities, relative to a given digital content object, may be associated in a distribution chain.

A network application hosting entity is an entity that operates or hosts a network application, such as a web site, blogging site, a social networking site (e.g., MySpace.com, Yahoo 360, and the like), or a web page hosting service. In some implementations, a single entity may be a content embedding entity and a network application hosting entity. For example, a news media site or other publisher may embed a given content item in one or more pages of its own site, where the servers and other resources are administered within its domain. In some instances, end-users of a network application hosting entity may be content embedding entities. For example, an end-user of a social networking site, such as My Space or Facebook, may embed content into her personal page. A network application hosting entity may also be compensated as a result of third party activity related to the embedded content.

A content sponsor is an entity that elects to sponsor one or more digital content objects. For example, a content sponsor may access a digital content object and pay or bid for the ability to have the digital content object be disseminated in connection with an ad, and/or link to an ad, identified by the content sponsor. In some implementations, digital content objects are disseminated with user interface elements (such as hypertext links or controls) that trigger a content sponsorship workflow.

A content consumer or end-user, in some implementations, is an entity that accesses network application hosting system 40 using a client node. One or more activities of content consumers, such as viewing embedded content and activating one or more links associated with the content, may result in compensation to one or more entities based on their respective roles relative to a given content item. Compensation, in some implementations, refers to a benefit, such as money, items, services, credits or points (redeemable for money, items, services, and the like) or any other benefit provided by one entity to another. In some particular implementations, one or more entities may share in revenues realized as a result of clickstream and/or purchase activity of a content consumer. In some implementations, a content consumer may also be a content embedding entity when he or she activates a distribution link or control associated with a given content object to generate content embedding code. In some instances, a content consumer may also be a content sponsor when he/she activates a sponsor link or control associated with a given content object.

A.4. Participant Identification and Authentication

In some particular implementations, content marketplace system 30 maintains user accounts for one or more of the entities discussed above. For example, content marketplace system 30 may maintain user accounts for content owners/uploaders and content sponsors. For example, content marketplace system 30 may maintain user accounts, storing user account information in data store 34. In some implementations, a user provides login or authentication information to gain access to his or her account information. User account information, in addition to a user name and password, may also include address and other personally identifying information and possibly financial account information (such as bank account and routing information which can be debited or credited). User account information may also include other information such as user preferences, and tags describing one or more aspects of the user. For content sponsors, user account information may also include records detailing sponsorship and other activity relating to one or more content objects selected by the content sponsor for sponsorship. A content marketplace system 30 may also store ad content uploaded by the content sponsor in association with a corresponding account.

A variety of authentication mechanisms can be used; as discussed above, a user name and password authentication mechanism is one suitable authentication scheme. To protect the initial login information, content marketplace system 30, for example, may employ Secure Sockets Layer (SSL) or other encryption mechanisms (such as HTTP-S).

In some implementations, discussed herein, users may access content marketplace system 30 using a browser, or other client application. After a successful login, content marketplace system 30, for example, may create a browser cookie with a corresponding user identifier or information that maps to the user identifier. Since the cookie is included in subsequent requests from the client application, content marketplace system 30 can automatically identify the user as he or she navigates the system (such as requesting content, uploading content, electing to upload content, and the like).

In some implementations, content owners or uploaders may have an account. In addition, content embedding entities may also have an account maintained by content marketplace system 30. Indeed, a single user may be a content owner relative to a first content object, a content embedding entity relative to a second content object, and a content sponsor relative to a third content object. In some implementations, users may register or apply for one or more roles in content-marketplace system 30. In other implementations, role permissions need not be explicitly defined in the user accounts.

### B. Registration of Digital Content Objects

In one implementation, a user (content owner/uploader) may access content marketplace system 30 to upload or register a digital content object, obtain content embedding code related to a digital content object, and/or sponsor a digital content object. In a particular implementation, a user (content uploader) may access content marketplace system 30 over computer network 60 with a client node to upload and/or register content. In one implementation, a special-purpose client application may be used to register and possibly upload digital content objects. In another implementation, client computer 82 includes a browser or other client application that parses and displays Hyper-Text Markup Language (HTML) pages transmitted from content marketplace system 30. In one implementation, content marketplace system 30 may transmit a page-based interface including functionality allowing a user to upload content.

FIG. 2 illustrates a work flow directed to registering a digital content object with content marketplace system 30 and generating content embedding code for the digital content object. As FIG. 2 illustrates, when a user accesses content distribution system, content marketplace system 30 may require a log-in process to establish the user's identity and account information (1402). A user log-in process may involve authentication wherein the user provides one or more credentials (e.g., a login identifier and password) that are validated by content marketplace system 30. As discussed above, a log-in process may also result in the generation of a browser cookie including user identifying information that is appended to HTTP or other requests transmitted from the user's client application to content marketplace system 30.

The user may then opt to register a given digital content object (1404). In a particular implementation, registration of a content object may involve a workflow where a user identifies a digital content object, and configures one or more attributes of the digital content object, and specifies one or more parameters relating to distribution of the digital content object (such as use permissions, and revenue sharing parameters). Identification of a digital content object may involve specifying a data locator for the digital content object, or uploading the digital content object to content marketplace system 30. In one implementation, the digital content object may be hosted by a remote content hosting site, for example. In such an implementation, the user may simply specify the data locator (e.g., a URL) corresponding to the digital content object. In other implementations, a uniform resource indicator (URI), identifying the content but not the specific location, can also be employed. A URI would resolve in a database system to a URL. In other implementations, the user may upload the digital content object to content marketplace system 30 for hosting. Registration of a digital content object may also include configuration of metadata or tags relating to, or characterizing one or more attributes of, the digital content object. For example, a page-based user interface provided by content marketplace system 30 may include a tags field into which a user may enter metadata, such as one or more tags or keywords that describe or relate to attributes of the content.

The tags associated with the content can vary considerably. The tags can relate to the subject of the content (subject, location, etc.), the circumstances involving creation of the content (date, author, time, image capture settings, etc.), and the like. Other data can be associated with the content. For example, the tags need not be entered by the user who uploaded the content. Rather, the tags or other information may be entered by other users after accessing and viewing the content on content marketplace system 30. In addition, one or more tags can be automatically extracted based on analysis of the content. For example, the digital file including the underlying content, such as an image or video, may also include one or more tags in reserved data fields. Other information can include the data, and time when the content was uploaded. In addition, if the content includes text, content distribution system, for example, can execute a programmatic process to extract one or more tags from the content. Still further, content may also be tagged with one or more geographical locations or geo-tags.

Registration of a digital content object may also involve configuration of one or more parameters related to distribution of the digital content object and/or revenue sharing parameters directed to sharing of revenues or other benefits that may arise out of distribution of the digital content object. For example, the user may specify the distribution and/or revenue sharing terms between the content owner/uploader, and one or more content embedding entities. For example, a content owner may specify the pay-for-placement and/or pay-per-click prices that a sponsor has to accept for sponsorship, or minimum prices if an auction format, is used. In some implementations, the revenue sharing terms may provide that only a subset of the content embedding entities in a distribution chain may share in revenues. In other implementations, the revenue sharing terms may indicate that no content embedding entity will share in revenues. A variety of revenue sharing arrangements can be configured without, departing from the scope of the present invention. Still further, registration of a digital content object may cause content distribution system to create an object instance record for the digital content object including one or more attributes, such as an object instance identifier, the tags specified by the user, a data locator for the digital content object, a user identifier corresponding to the user, as well as distribution and/or revenue sharing parameters. As discussed below, additional instance identifiers corresponding to the digital content object may be subsequently created and refer back to the originally-created instance identifier as content, embedding entities access content marketplace system 30 and include content embedding code in underlying network resources, such as HTML pages or other digital content objects.

After registration of the digital content object, content marketplace system 30 may generate content embedding code including distribution and sponsorship code sections (1406), as described in more detail below. The content marketplace system 30 may provide the content embedding code to the user (1408), in one implementation, transmitting a page-based interface including source code (e.g., HTML code) or a separate data file (1408). The user may then use the content embedding code, such as inserting it into an underlying HTML page. When the page is published and requested, by a browser or other client application, the content embedding code is operative, when parsed, to access the digital content object and render it in connection with one or more hypertext links (or other user-activated controls), as described below. The content embedding code may also be provided to other users in page-based interfaces (or in connection with a media object viewer or player) in connection with the digital content object.

In addition, content marketplace system 30 includes a search interface allowing other users to search and browse digital content objects that have been uploaded to, or registered with, content marketplace system 30. In such as configuration, the content marketplace system 30 may display or otherwise make available to users content embedding code for the digital content objects to allow users to embed the digital content objects. In addition, the content marketplace system may also display the digital content object in connection with sponsor links or controls that, when activated, initiate workflows directed to sponsoring the digital content object.

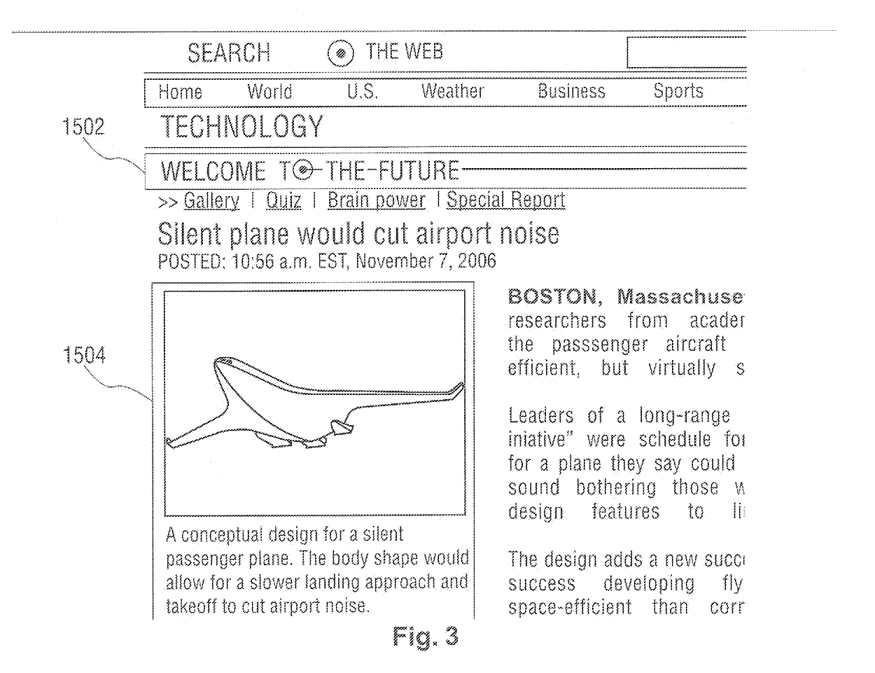

Still further, a variety of other implementations are possible. For example, content object registration and content embedding code generation can be an automated process performed in connection with the dynamic generation of HTML pages or other network resources, such as flash objects, or other media files. Consider for didactic purposes, HTML page 1502 depicted in FIG. 3. As FIG. 3 illustrates, HTML page 1502 includes a digital content object 1504 (here, a digital image). In one implementation, the functionality of content marketplace system 30 can be exposed to other network hosts as a set of Application Programming Interfaces (APIs). For example, content marketplace system 30 may support web services protocols, such as the Simple Object Access Protocol (SOAP). In such an implementation, a user may embed one or more API calls (either as HTML code, Javascript or other language) to content marketplace system 30 in the source code of HTML page 1502. Such a call might also be implemented in .asp or .jsp pages, for example. In one implementation, execution of these calls will at some point during construction of the HTML page cause a server, for example, to submit relevant media information obtained from the media asset database used by a dynamic page publishing system.

For example, during dynamic construction of a web page at a web sewer (or a client application), a host may transmit a message or request to content distribution system to register a content object and receive content embedding code in response. In one implementation, the message may include an identifier for the digital content object, one or more tags or keywords, one or more account identifiers, one or more distribution parameters, and/or one or more revenue sharing parameters. The message may also include authentication information. Furthermore, the message may also be encrypted using secret shared key or public-private key encryption technologies. In implementations involving dynamic generation of web pages at the server side, the automated process may also involve a separate exchange of messages in an authentication process. In one implementation, the server implementing the dynamic page generation code receives and incorporates the content embedding code into the HTML page or other resource.

### C. Content Embedding, Content-Embedding Code and Activation of Sponsorship and Distribution

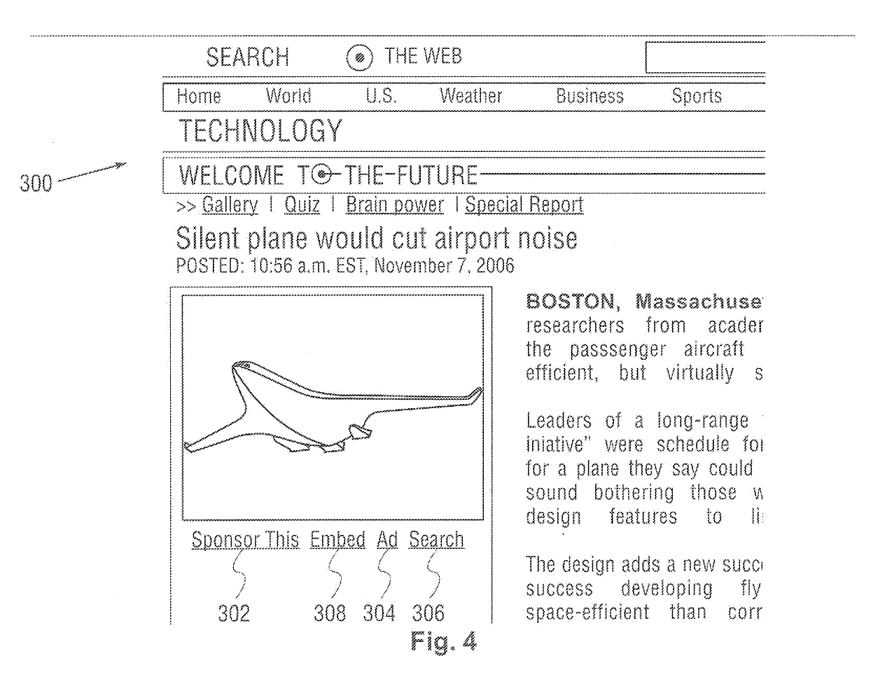

FIG. 4 illustrates the results of the content registration and the generation of content embedding code described herein which may result for the manual or automated processes described herein. FIG. 4 shows the essentially the same HTML page as that illustrates in FIG. 3; however, the HTML page further includes one or more code sections operative to present respective hypertext links on the HTML page. For example, the hypertext links may include a sponsor link 302, an ad link 304, and a search link 306. In addition, the hypertext link may also include a distribution link 308. Note these links can be text-based or graphic-based controls. Furthermore, the links may respond to clicks, mouse-overs, and/or other activations. Furthermore, the links may be implemented in HTML code or in Flash or other media object files. Other implementations are also possible. For example, the text or a small banner associated with a selected ad may be displayed adjacent one or more of the borders of the rendered digital object. Furthermore, selected ad text may be displayed as an overlay in a corner of the rendered object. Furthermore, the rendered object region may be clickable, where user clicks resolve to a selected ad.

C.1. Distribution Controls

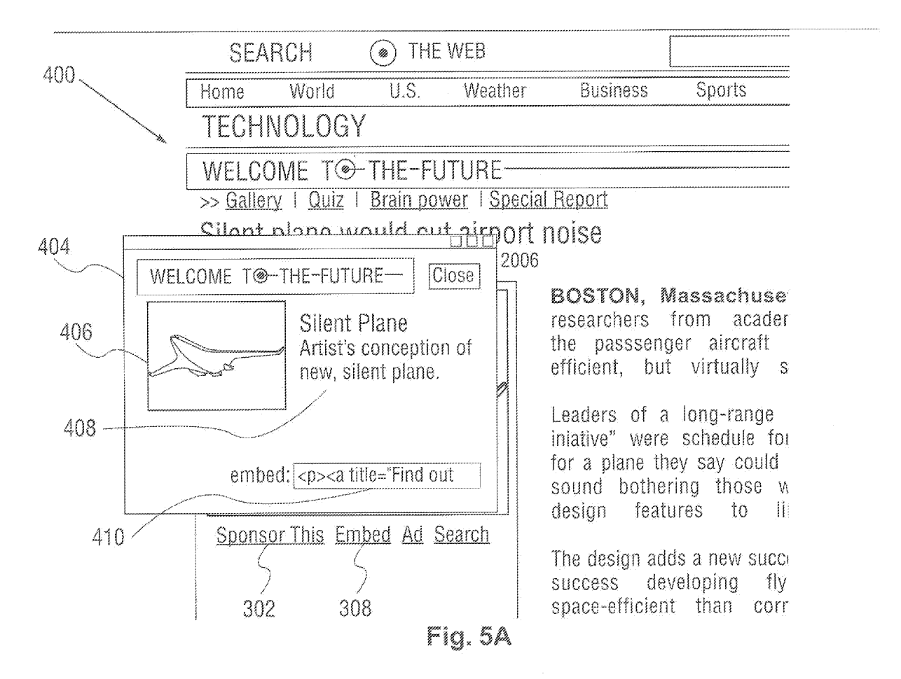

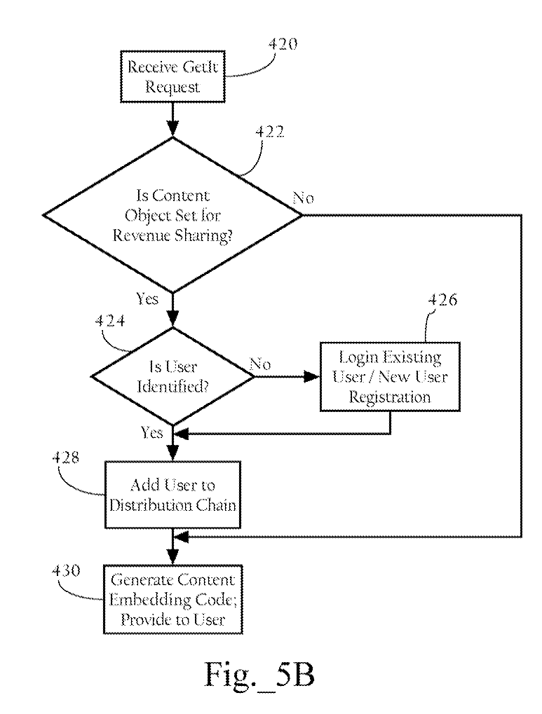

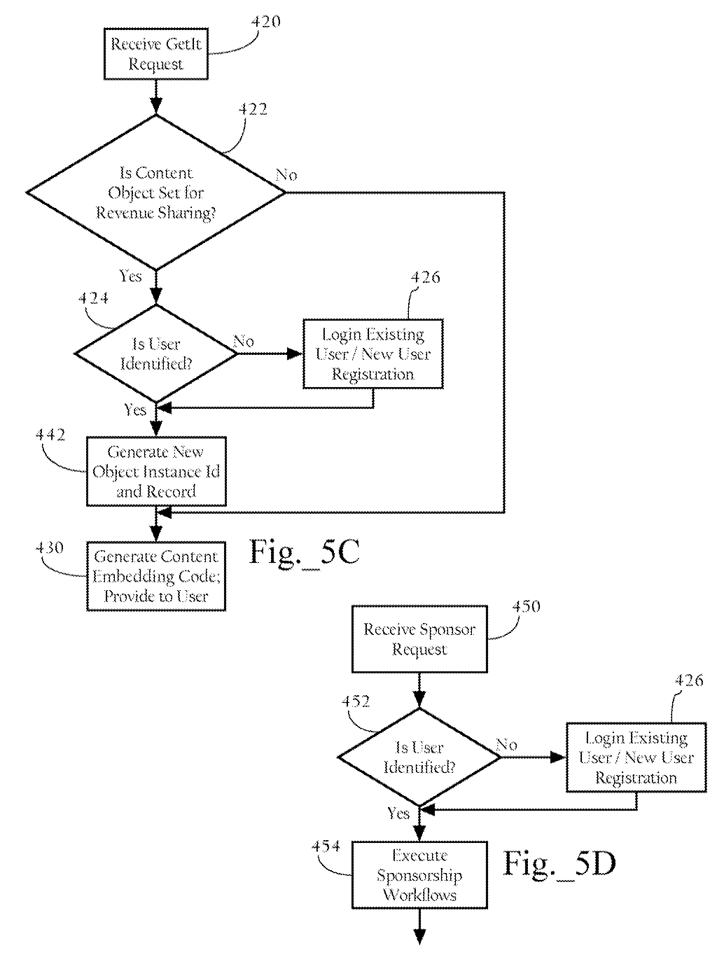

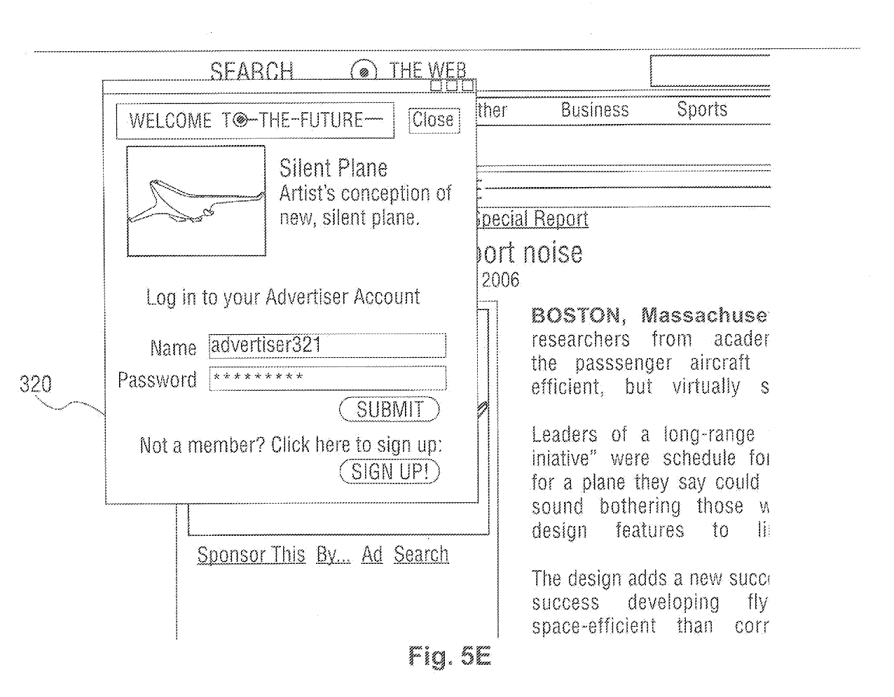

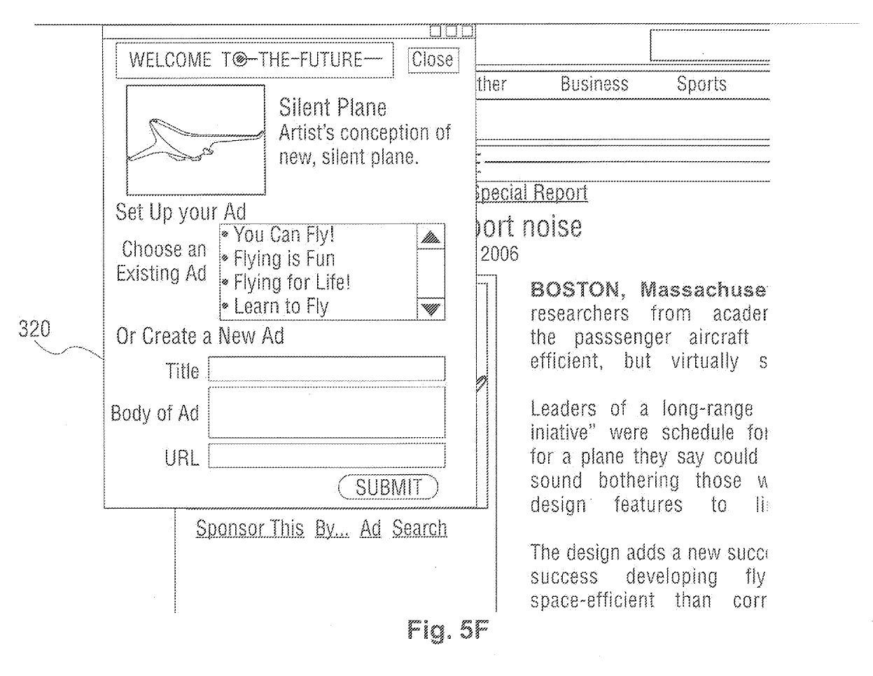

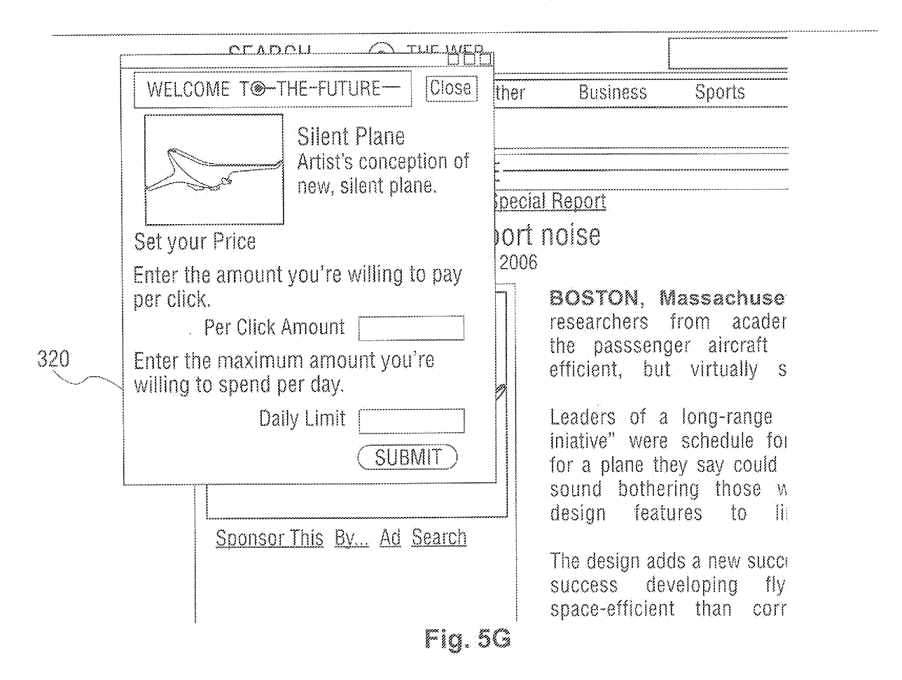

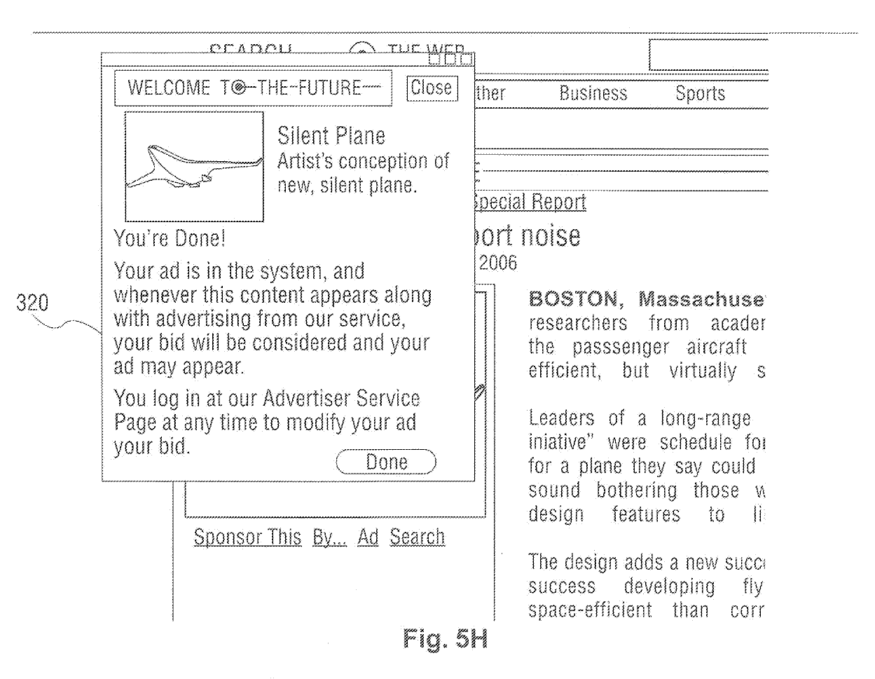

FIG. 5A illustrates an example result of activating a distribution link 308. Page 400 has been constructed to include relevant link functionality, as described above. Activation (e.g., a user click or mouse-over) of the distribution link 308 causes, in one particular implementation, a point of presence distribution interface (e.g., a pop-up window 404) to appear. In one implementation, activation of the distribution link 308 causes a browser or other client application to access content marketplace system 30 that dynamically generates the content embedding code and renders distribution interface in pop-up window 404. In this manner, the end-users identifying information may possibly be obtained in a browser cookie, as described in more detail below. This window could also be displayed in a new section within the page itself, using AJAX, Flash or other technologies. Furthermore, though not illustrated here, the distribution interface can also contain some combination of a displayed ad, sponsored search links, copyright or other rights information, links to content marketplace system 30, and the like. In one implementation, the distribution interface may also include a confirming thumbnail 406 displaying the media that the user can obtain for publication. In some implementations, the distribution interface may also include descriptive information 408. In the implementation shown, the distribution interface also includes an embed field 410 containing content embedding code which the user may select and copy. In one implementation, the embed field 410 includes content-embedding code, which can be used to embed, and display the content in other underlying content. For example, the content-embedding code may comprise HTML code that can be inserted into an HTML page corresponding to an information web page, a blog page, an on-line forum, or a personal page on a social network site. The content embedding code provided in embed field 410 may be a) identical to, or substantially the same as, that in the underlying page 400; b) modified to indicate that the digital content object was obtained through a distribution interface; and c) modified to include a reference to the obtaining user (assuming the obtaining user can be identified). Such identifying information can be used to help track dissemination of a given digital content object, and also to support multi-level revenue sharing.

FIG. 5B illustrates a process that may be executed at content distribution system in response to activation of a distribution link. As discussed above, activation of a distribution link may cause a client application to transmit a request to content marketplace system 30. In one implementation, the request may include an instance identifier or other information allowing content marketplace system 30 to identify the digital content object and other information associated with registration of the digital content object. When content marketplace system 30 receives the request (420), it accesses one or more instance records identified in, or associated with, the request to ascertain whether the digital content object is set for revenue sharing with content embedding entities (422). If not, content marketplace system 30 may generate the same content embedding code as in the underlying page (e.g., page 400 of FIG. 4) in the embed field 410. Otherwise, content marketplace system 30 determines whether the current user is identified (424). For example, the request may include an appended browser cookie with user identifying information. If the cookie is invalid (e.g., timed out, invalid account) or does not exist, content marketplace system 30 enters a log-in process for existing users, or an account registration process for new users (428). If the user is sufficiently identified, content marketplace system 30 adds the user to a distribution chain of content embedding entities in a record associated with digital content object (428), generates content embedding code and provides it to the user in the embed field 410 of the distribution interface (430). Given that the same set of links may be displayed, the use of the distribution link by subsequent users may create one or more distribution chains of content embedding entities. FIG. 5C illustrates an example method that may facilitate this aspect of certain implementations of the invention. As FIG. 5C illustrates, content marketplace system 30 may generate a new object instance identifier and record in response to the received request. In one implementation, the newly generated record may be linked to the object instance record identified in the request. In such an implementation, the object instance records may be traversed to ascertain one more distribution chains associated with a digital content object. This may be useful for identifying one or more entities associated with a given distribution chain in connection with revenue sharing.

As discussed above, the user may then use the content embedding code in an underlying resource, such as an HTML page, causing the digital content object and the links discussed above to be displayed to other users when accessed. In the particular implementation shown, the content-embedding code in the embed field 410 is source code, such as HTML code, presented as plain text (and therefore not parsed, rendered or otherwise processed by a browser or other client application). A content embedding entity may use the content-embedding code by manually copying the content-embedding code in the embed field 410 and inserting it into a desired content file or object. In one Implementation, the content embedding entity may highlight the content embedding code in the embed field 410, use “copy” or “cut” commands to load the code into a temporary buffer, and “paste” the selected content-embedding code in one or more desired locations in an underlying data or content file. In another implementation, tire distribution interface may include an “embed” control, such as a hypertext link, or command button, which activates a script that automatically loads the content-embedding code into the temporary buffer. In yet another implementation, the embed control may cause a temporary text box, or a pop-up window, containing the content-embedding code to appear. The user may then select the content embedding code and paste it into a desired location or file. In another implementation, distribution interface may include a hyperlink to the content-embedding code that, when activated, causes a remote system to generate the content-embedding code on demand, and return it to the requesting node.

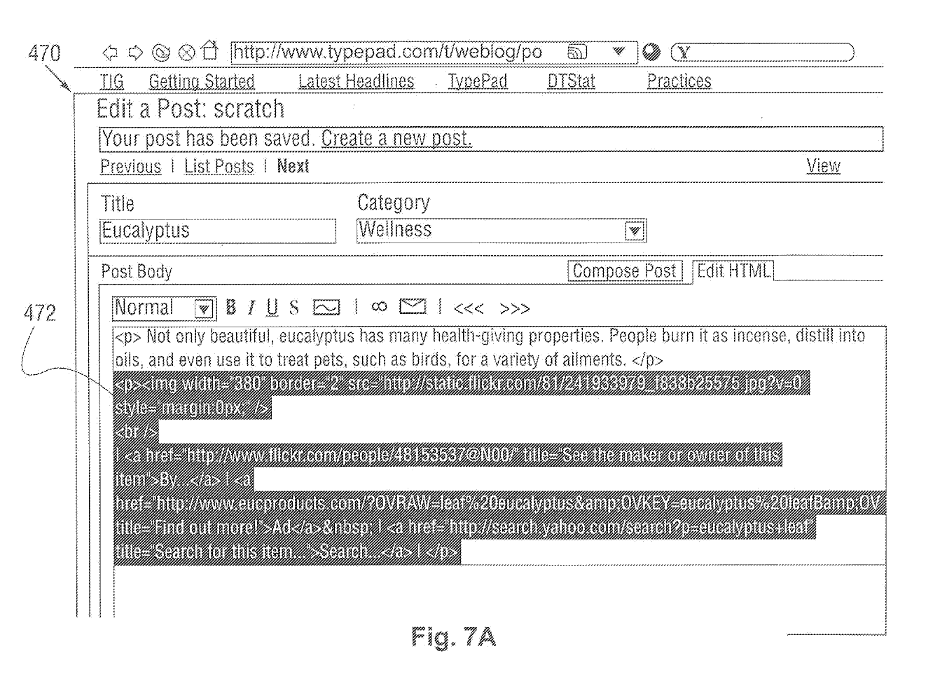

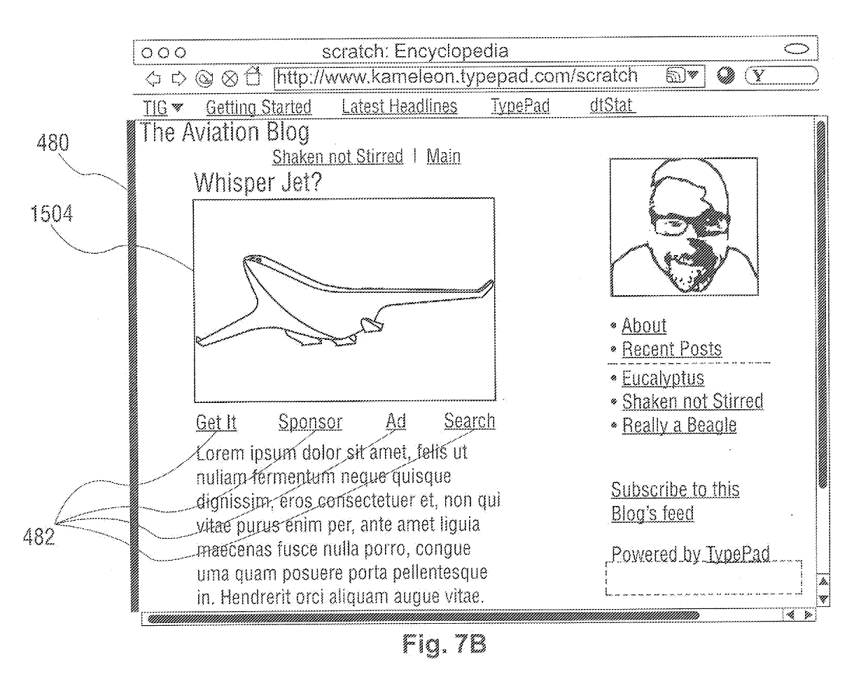

In some implementations, the content embedding code can be stored in a data file (such as a text file) for later use by the content embedding entity. For example, the content embedding entity may opt to store the content-embedding code in a text file on a client node for later use. In some implementations, the content embedding entity may opt to store the content embedding file in a user account on content distribution system. Still further, FIG. 7A shows an example interface 470 facilitating the configuration of a blog post including content-embedding code inserted therein. When configuring the blog post, a content embedding entity may paste the HTML code 472 copied from the embed field 410 into the HTML code of the blog page. In the implementation shown in FIG. 7A, interface 400 includes an “edit HTML” tab that allows a user to directly edit the HTML code of the blog post. When parsed by a browser or other client application, for instance, the content-embedding code 472 causes the browser to retrieve the content and display it in connection with one or more links. The content-embedding code may be incorporated into a variety of systems, such as information systems, and social networking systems. Indeed, a blog post represents one of many possible forms of social media in connection with which the content-embedding code can be used. For example, the content-embedding code may be incorporated into personal pages on social networking sites, such as MySpace.com, Facebook, Yahoo! 360, and the like. The content-embedding code may also be used by a content-embedding entity in other contexts. For example, the content-embedding code may be entered into a thread on a public forum site. For example, a content-embedding entity may find an image of an automobile on content site 20. The content-embedding entity may then incorporate the image by pasting the content-embedding code 472 into a post on a public automobile forum. Still further, a webmaster or other user may include the content-embedding code into one or more pages of a web site, such as a commercial news site (e.g., cnn.com, zdnet.com, etc.).

FIG. 7B illustrates an example blog page 480 including embedded content. In posting the illustrated blog, the content-embedding entity (here, a blog poster) has entered written text and the content-embedding code that causes selected content to be displayed. As FIG. 7B illustrates, the blog page 480 includes distribution, attribution, advertisement and search locators as hypertext links 482, respectively, displayed in connection with the digital content object 1504. Note that other links and information can be displayed along with the content. For example, the same mechanism can be used to display a “Share” link that pops up a window inviting the viewer to supply one or more email addresses. Completion of the work flows of the share link may cause an HTML-based message, including the content embedding code, to be transmitted to the recipients. The recipients, upon accessing the message, would be presented with the content and the one or more links contained in the content-embedding code. Another link might be an “IM” link invoking an instant messenger session with the content owner, and so on. Furthermore, the content-embedding code may be configured to embed the content as an activatable region, such as an HTML image map encoded with a selected link (such as an advertising or search link). If a user clicks within this region, the link associated with the region is activated, causing the client application to transmit a request, to the server identified in the link.

As one can appreciate, operation of various implementations described above create a viral distribution mechanism. That is, a first content embedding entity may view a digital content object and click the distribution link to obtain content embedding code and use the code in a blog page (for example). Thereafter, a second content embedding entity may view that blog page, click on the distribution link to receive content embedding code, and use the content embedding code in a social network page (for example). Yet a third content embedding entity may view that social networking page and obtain content embedding code (as described above) and use it in an information web site. Furthermore, as discussed above, each of these content embedding entities comprise a distribution chain and may share in revenue or other benefits resulting from activation of advertisement or search links. For example, if an end-user clicks on an ad link when view the blog page (above), the first and second content embedding entities may share in resulting revenues (assuming the content owner has configured revenue sharing parameters in that manner). Still further, other users viewing the digital content object anywhere in the chain of distribution may activate a sponsor control to initiate a sponsorship workflow.

C.2. Sponsorship Controls

FIG. 5D illustrates an example process flow that may be initiated in response to activation of a sponsor link 302. FIGS. 5E thru 5H illustrate various point of presence sponsorship interfaces that may be displayed to a user during a sponsorship work flow. When a user activates sponsor link 302, a client application, such as a browser, may compose a sponsor request, which is received by content marketplace system 30 (450). As discussed above, the request may include a cookie or other data structure appended to (or otherwise included with) the sponsor request. Content marketplace system 30 may use user identifying information in the cookie (as well as time stamps, and the like) to identify the user (452). If the user is not sufficiently identified (e.g., expired cookie, or invalid user identification), content marketplace system 30 may initiate a login/authentication workflow (426). As FIG. 5E illustrates, a point of presence sponsorship interface 320 may be rendered on a display and prompt the user for account log-in information. If the user is sufficiently identified (e.g., having a valid cookie with a valid user identifier), content marketplace system 30 may initiate a sponsorship workflow (454) to allow the user to review information about the content object and potentially sponsor it. In one implementation, activation of the sponsor link 302 initiates a pop-up window, similar to that described above, on which various interfaces associated with the sponsorship workflow are displayed to the user. The sponsor interface may be implemented as a browser window, or a window rendered by a plug-in application, such as a Flash media player.

Sponsorship workflows can vary considerably without departing for the scope of the present invention. In a particular implementation, content marketplace system 30 may transmit an interface allowing the user to preview the digital content object, and to select an existing ad from the user's account, or create a new ad, as FIG. 5F illustrates. As FIG. 5G illustrates, another interface may prompt the user to enter pay-per-click and daily limit amounts. As shown in FIG. 5H, the system may also provide an order or bid confirmation to the user. Additional interfaces may also allow the user to view various distribution parameters specified by the content owner, statistics associated with the digital content object (e.g., the number of consuming user accesses, the number of content embedding entity accesses, pay-per-impression statistics, pay-per-click statistics, etc.), and price or bid parameters (e.g., the cost of sponsoring the digital content object relative to impressions, clicks, and the like). For example, a sponsor may see that a given video embedded in a social media page has been viewed 40,000 times, and may further see the timespan within which these views has taken place, and the rate of acceleration, if any, in the number of views over time, all relevant information in making a decision to sponsor at a given cost.

A sponsoring user may elect to sponsor the content or submit a bid to sponsor the content by entering a payment amount, and one or more ad objects to be used in connection with the sponsorship. For example, a sponsor see in a sponsor interface a set price for sponsorship provided by the content owner, and agree to pay that price by activating a control. Alternatively, a sponsor may bid on the content, and find out then if his bid has been accepted, or find that due to fluctuating bids by other sponsors it has been accepted in some percentage of subsequent displays. In some implementations, the sponsor may use other bidding models, including automatic incrementing of bid relative to other bidders up to a set ceiling (or an unlimited amount). In some implementations, a second sponsor may decide to attempt sponsoring the same content object, in which case the first, sponsor may receive a notification about the attempt, or about successful attempts, and so on, enabling the first sponsor to respond with a counter-bid if the pricing is on such a variable, auction-style model.

As discussed above, a sponsor may also indicate which ad to display upon acceptance of the sponsorship order or bid. For example, the sponsor may also, in a related interface, modify an existing ad, or create or otherwise provide a new ad for use in this sponsorship. When the advertiser's ad is accepted, display code associated with the digital content object, which the user has sponsored, is configured to link to the sponsor's advertisement when the content is accessed by consuming users. Advertisements can take a variety of forms, such as text ads (including slogans, brand names, and URLs that resolve to a web page), banner ads, small animations and the like.

C.3. Content-Embedding Code

Content-embedding code may take many forms. For example, content-embedding code may be source code, such as HTML code, or object code. Content-embedding code may also include one or more scripts, such as JavaScript, expressing functions that are embedded in or included from HTML code. These script, functions can interact with the Document Object Model (DOM) of the page to perform one or more tasks. Scripts may also be used to make calls to remote servers after an HTML page has loaded. These calls can obtain new information or data, which additional script code can merge with the DOM of the existing page so that it is displayed or otherwise rendered. In addition, scripts or content embedding code may include calls to access or invoke a player or viewer for the digital content object.

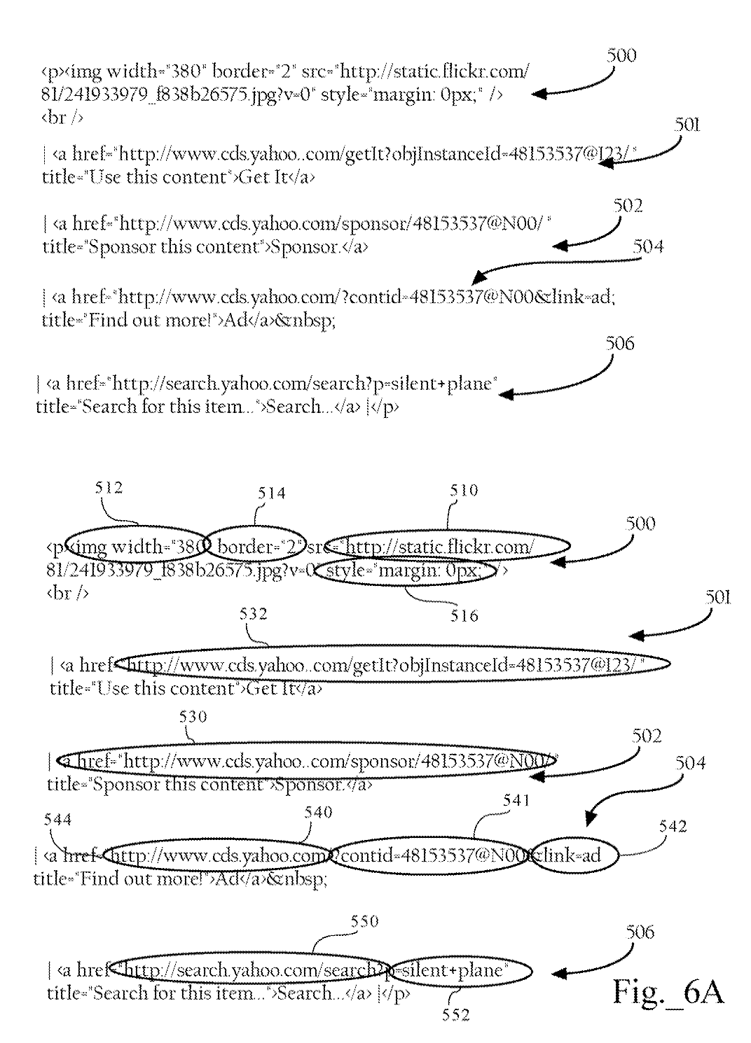

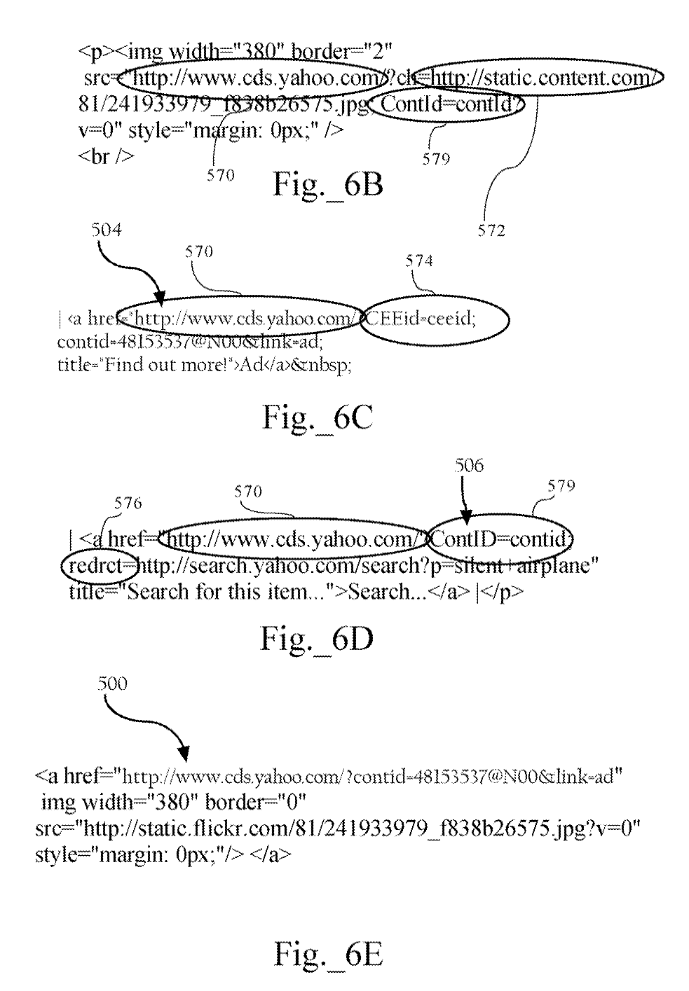

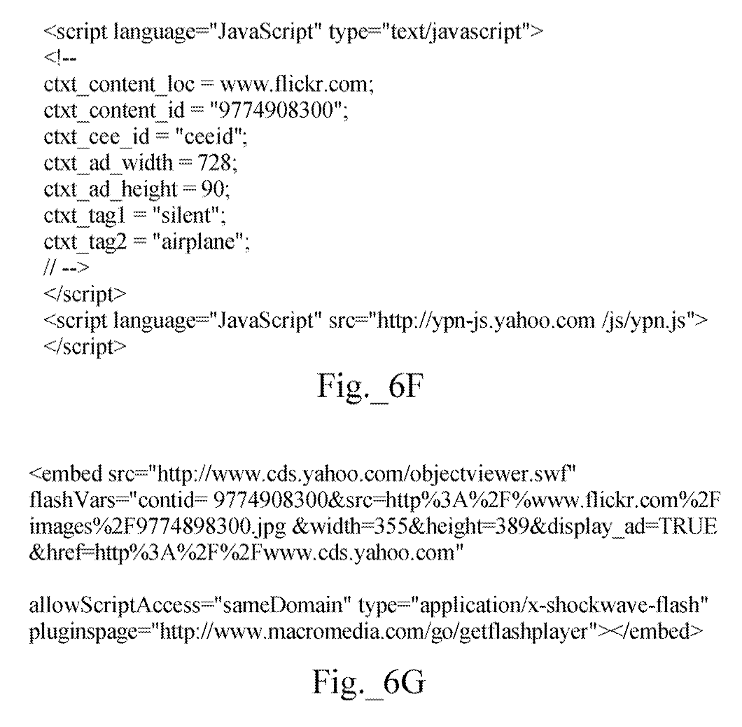

FIG. 6A illustrates the elements of example content-embedding code according to one particular implementation of the invention. In the implementation shown, the content-embedding code includes content code section 500, a distribution code section, a sponsor code section 502, an advertisement code section 504, and a search code section 506. Content code section 500 includes a content locator 510, such as a URL corresponding to the content to be embedded. The content locator 510 may include a URL of the system that hosts the content, such as content hosting site 20. In other implementations, as FIG. 6B illustrates, the content, locator 510 may include a URL 570 corresponding to content marketplace system 30 with a URL of the content as an encoded parameter. In this implementation, the URL may include parameter information, such as a URL 572 or an identifier that maps to a URL, identifying the system hosting the content. The URL may also include a content object identifier 579, as well. Content marketplace system 30 can track and/or control content usage (where the content is stored remotely from content marketplace system 30), and redirect the client application to the system hosting the content. Content code section 500 may also comprise formatting or other information. For example, tags 512, 514, and 516 indicate the width, border and style to be used when displaying the content. One or more of the resource locators or indicators in the content embedding code may be formatted as hypertext links, which can be activated by a user click.

Distribution code section 501 Includes a URL 532 corresponding to content marketplace system 30. In one implementation, the URL 532 includes an object instance identifier as a parameter. Sponsor code section 502 includes a sponsorship URL 530 corresponding to content marketplace system 30. Activation of the link resulting from tire sponsor code section 502 initiates a workflow directed to sponsoring the content.

Advertisement code section 504 includes an advertisement locator 540, which when activated causes an advertisement to be displayed. The advertisement locator may take a variety of forms. For example, the advertisement locator may be a fixed or static URL that, when activated, causes a browser or other page-consuming client application to transmit a request to a network addressable resource, such as a web server, and receive an advertisement. In one implementation, the advertisement locator may be embodied in a hypertext fink including the URL of content marketplace system 30, and a static URL corresponding to an advertisement in a Common Gateway Interface (CGI) command. In another implementation, the advertisement URL includes a digital content object identifier, allowing content marketplace system 30 to dynamically select an advertisement. When the advertisement link is activated, the client application transmits a request to content marketplace system 30, which transmits a redirection message to the browser.

In the particular implementation shown, the advertisement locator 540 comprises a URL of content marketplace system 30 (www.cds.yahoo.com) and includes as parameters the content object identifier 541 and a link type identifier 542 (here, indicating that the link is an ad link). In the implementation shown, when the advertisement link is activated, the client application transmits a request to content marketplace system 30 (www.cds.yahoo.com), which transmits a redirection message to the client application. The redirection message redirects the client application to a network resource that hosts an ad or other content. The use of redirection messages allows content marketplace system 30 to track content and link usage, as well as dynamically select the ad to be served to the consuming user who activated the ad link.

Other implementations are possible. As FIG. 6C illustrates, the advertisement code section 504 may also include one or more identifiers each corresponding to a different user or entity. For example, the advertisement code section 504 may include a user identifier 574 corresponding to the content embedding entity that embedded the content in an underlying resource, such as a blog page, web site, personal page, and the like. In addition, the advertisement code section 504 may include a plurality of content embedding entity identifiers associated with the distribution chain of the digital content object. As discussed in more detail below, one or more of these identifiers may be used in the benefit or revenue sharing mechanisms described herein. Still further, the content object can also be encoded in the advertisement code section 504 to allow content marketplace system 30, for example, to track the content, objects that generate clickstream activity. In one implementation, the value of the content identifier corresponds to an object instance identifier (see above). In one implementation, the object instance identifier can be used to identify the content embedding entity directly related to activation of the ad link, as well as one or more content embedding entities in the distribution chain. This information can be used in revenue sharing arrangements that provide for sharing of revenue between two or more content embedding entities in the distribution chain.

As FIG. 6A shows, the search code section 508 may also include a search locator 550 operative, when activated, to provide search results related to the content. The search locator may comprise a URL of a search system 70 and one or more keywords 552, such as the respective values of one or more tags associated with the content. Activation of the search locator, such as clicking on a hypertext link, may results in a page of search results. The search results may include one or more links to sponsored content or paid search marketing ads in addition to, or in lieu of, algorithmic search results. The search code section 506 may also include one or more of the entity identifiers discussed above (e.g., content owner, content embedding entity, content host, etc.) to be used in a benefit attachment mechanism. For example, the search code section 506 may include an identifier 574 of one or more content embedding entities, who may share in the resulting revenue, if a third party who views the content clicks on the search fink and, subsequently, a link to a sponsored search result. A share of revenue may also be provided to the content owner/provider. In one particular implementation, an identifier for the content owner may also be included. In another implementation, search code section 506 may include an identifier 579 corresponding to content object (see above). A search system can use these entity identifiers to code one more redirection links returned in the search results.

Other implementations are also possible. As FIG. 6D illustrates, for example, the search code section 506 may include a URL that identifies content marketplace system 30 (Ref. No. 570), and includes a content identifier. As discussed below, activation of such a link would transmit a message to content marketplace system 30, which could log the content identifier 579 (for example), and then redirect (see Ref. No. 576) the client node to search system 70. In one implementation, the redirection message could also include the content identifier 579 to allow the search system 70 to code one or more finks to search results (such as one or more sponsored links) with the identifiers. If a user clicks on one of the coded links, content identifier 579 can be used to compensate one or more entities in the distribution chain.

In one implementation, the content, such as an image, can itself be clickable, where a user click resolves to an ad link, a search link or an attribution link, above. As FIG. 6E illustrates, the content code section 500 may include HTML code that renders the displayed image clickable, resolving, for example, to an advertiser system through redirection messages. The link associated with the content, however, can incorporate a variety of the link types and data elements described herein.

Additionally, one or more aspects of the content embedding code may be dynamically generated. For example, if the content embedding entity is logged into content marketplace system 30, the identifier of the content embedding entity can be dynamically added to one or more sections of the content embedding code. In addition, the content-embedding code may be dynamically generated during creation of the page to add the current tags associated with the content. In some implementations, one or more of the tags may also be dynamically generated upon activation of one of the links.

Content embedding code may also include other link types, such as a “buy content” link. In one particular implementation, activation of a “buy content” link initiates a purchase work flow on a remote server, where, for example, a user could purchase a higher quality digital image of the image content displayed in connection with the link, or a framed copy of the image. As discussed above, a share link may include HTML code that causes a client node to generate an email configuration interface including the content-embedding code. The email can be configured as an HTML email, which when accessed by the recipients may present the content and one or more links in a manner similar to that depicted in FIG. 7B. Still further, a “contact owner” link can include code that causes a client, node to generate an email configuration interface designating the content owner as the recipient.

In some implementations, one or more sections of the content-embedding code may contain a script, or calls to retrieve a script, that dynamically generates one or more aspects of the links provided when the embedded content is accessed. In other implementations, content embedding code may also contain calls to media object players or viewers. FIG. 6F illustrates an example content embedding code that is operative to invoke a script that forms the locators and links discussed herein. For example, the content embedding code includes the location of a server hosting the content, an identifier of the content (typically, an object instance identifier), a content embedding entity identifier, a content owner identifier, one or more tags, and formatting parameters. The content embedding entity also includes a URL to a script. Generation of the content-embedding code that retrieves the script may be similar to the foregoing. Content marketplace system 30, for example, may obtain the entity information and tags and construct content-embedding code similar in format to that shown in FIG. 6F.

In one implementation, shown, when the content-embedding code is inserted into an HTML document and subsequently accessed by a client application, the client application may retrieve and execute the script. The script may, using the parameter values in the content embedding code, may make calls to one or more remote servers to retrieve and render the content, as well as generate one or more of the links described herein. For example, the script, when executed, may cause the client application to query content marketplace system 30 for an ad URL, and then render the identified content as a clickable region that, when clicked, resolves to the ad URL.

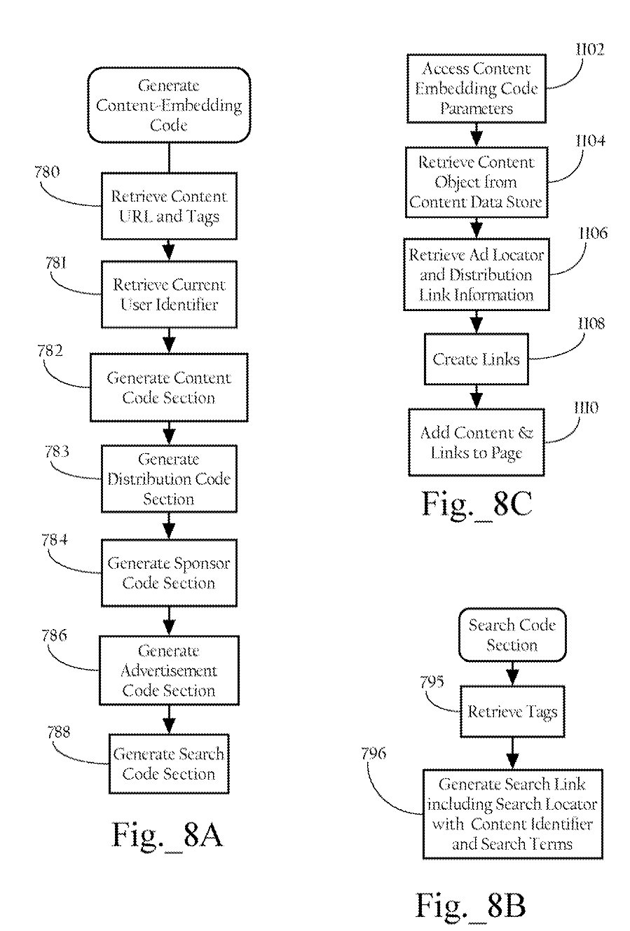

FIG. 8C illustrates an example method that can be implemented by a script that dynamically generates content embedding code. As FIG. 8C illustrates, the script, when invoked, may access the content-embedding code parameters (1102), and retrieve the content object, identified in these parameters (1104). Using the parameters of the content-embedding code, the script may retrieve ad and distribution link information. For example, the script may use the object instance identifier to retrieve information for the ad and distribution link links (1106). The script may then create one or more of the links discussed herein (e.g., ad, search, or sponsor links) (1108), and add the content object and links to the underlying HTML page (1110).

In other implementations, the script, when executed, may retrieve creative banner ad content and render it next to the content. Ad selection, in both instances, can be based on one or more of tags associated with the digital content object, or can be based on the pool of ads configured by the sponsor of the digital content object. In yet another embodiment, the script, when executed may query a search system for one or more sponsored search links and render the returned search links adjacent to the content identified in the content-embedding code. In one implementation, the script may render the content as a clickable region that resolves to one of the sponsored search results, such as the highest ranking sponsored search result. In some implementations, the search links may be selected from a set of search links configured by the content sponsor.

Still further, the script may encode the content identifier, the content embedding entity identifier, the content owner identifier or other entity identifier contained in the content embedding code into one or more of the URLs of the links. For example, the script may add the content identifier to the ad link to allow this entity to be credited if an end-user clicks on the ad link. As discussed herein, in one implementation, the ad link may cause one or more redirection messages to be transmitted. The script, when executed, may also make remote calls to content marketplace system 30. For example, the script may transmit a message including the content identifier to content marketplace system 30, allowing it to maintain usage statistics in connection with the content object. In one implementation, this may enable the content owner, for example, to be compensated based on the number of times the content was accessed.

Still further, as FIG. 6G shows, content embedding code may include calls to access a wrapper or container object, such as a Flash object, that in connection with a content object media player, can be used to render the content in association with one or more interactive controls that a consuming user may activate to sponsor the content object, get content embedding code for the object and the like. As FIG. 6G illustrates, the content embedding code may include a call to a Flash® object (contentviewer.swf) that can operate in connection with a Flash® media player, which may operate as a plug-in to a browser client. In one implementation, the wrapper object may be configured to display the selected ad in one or more selected regions of a graphical user interface. For example, a small text ad, activatable with a user click that resolves to a URL, can be displayed above the content. In some implementations, an advertiser logo can be displayed as an overlay. In the implementation shown, the content embedding code may includes a call to a Shockwave or Flash media player offered by Adobe Systems, Inc. of San Jose, Calif. Shockwave and Flash media players support container formats that allow underlying content objects (e.g., videos, images, animations, and jpegs), as well as ad content, to be accessed remotely and rendered, and allow for additional interactivity with the objects, such as controls, links, overlays, and the like. For example, this media player can be invoked to display a digital content object, such as a jpeg or other image and include one or more user interface controls that a consuming user may use to initiate a sponsorship workflow, get content embedding code for the object, and the like. The media player may also display or render an interactive ad in connection with the media object. Flash, due to its container format, can also be used in connection with video and other media objects. Other media and content object viewers can be used, such as Windows Media Player, Yahoo! Music Engine client, and the like. As FIG. 6G illustrates, the content embedding code may include parameters, such as URLs, content object identifiers, content embedding entity identifiers, identifiers for underlying flash objects or applets that support the sponsor, distribution and ad functionality described herein, as well as other parameters. Other implementations are possible. For example, the flash object may be encapsulated with the media player to create a self-contained object. In one implementation, the flash object, when downloaded and executed on a client, can access the media objects defined in the content embedding code and render the object and any interactive controls. In another implementation, the parameters of the content embedding code may be passed to a remote server which constructs a wrapper object with the media and controls and transmits the completed object to the client application. In either implementation, the encapsulated digital content object and the embedding and sponsorship functionality encapsulated with it can be readily shared and exchanged.

B.2. Content-Embedding Code Generation

Various aspects of the content-embedding code may be statically or dynamically defined. In addition, the content-embedding code can be generated by a variety of different systems or nodes. For example, the content-embedding code may be generated in response to accessing a digital content object, or upon activation of a “distribution” link or control.

FIGS. 8A and 8B illustrate example methods for generating content-embedding code according to one possible implementation of the invention. Generation of the distribution code section has been described above. In some implementations, some aspects of the content-embedding code may be dynamically defined. In some implementations, for example, some portions of the content-embedding code can be defined in response to activation of a distribution link, which causes a client application to transmit a request for content embedding code. Content embedding code may also be generated, for example, when a user browses available content on content marketplace system 30. In such an implementation content embedding code may be generated with each new page access. The implementation described below operates as part of the process flow illustrated in FIG. 5C. As described above, a request for content embedding code may include an object Instance Identifier corresponding to an object instance record containing information, or pointing to another object instance record containing such information, used to generate various aspects of the content, embedding code. In some implementations, various attributes of the digital content object may also be passed in the request. Still further, as illustrated in FIG. 5C, the identity of the user requesting the content embedding code is also ascertained, and a new object instance identifier has been created. As FIG. 8A shows, server 32 can retrieve the tags, content locator and other metadata associated with the content (780), and use this data to generate one or more aspects of the content-embedding code. In some implementations, server 32 may retrieve the identifier of the user currently accessing content marketplace system 30 (781). In one implementation, the user identifier may be contained in a browser cookie, and/or maintained as server-side state information. This identifier may be a content-embedding entity identifier 575 included in one or more of the advertising code or search code sections 504, 506 discussed above. Server 32 then generates the content code section 500 including a content locator to the content (782), a distribution code section (783), an sponsorship code section 502 (784), an advertisement code section 504 (786), and a search code section 506 (788). In some implementations, one or more of the foregoing code sections can be omitted. For example, for implementations using media players or scripts, the required parameter values and other variables may be included in a listing as shown.

To generate an advertisement code section 504, server 32 may compose a URL including a content object identifier or instance identifier. Server 32 generates an advertisement link, in one implementation, with the value of the object instance identifier as the content identifier 579. As FIG. 8B illustrates, to compose a search code section 506, server 32 may retrieve one or more tags associated with the content object (795) and generate a search link, in one implementation, with the content identifier 579 and a search locator including one or more search terms based on the tags (798). As discussed above, a variety of other implementations are possible. Still further, the tags may be processed to yield alternative or additional keywords used in ad selection or in subsequent search processes.

### D. Content Access and Link Activation Process and Message Flows

Use of content embedding code and activation of the links in content-embedding code can initiate a variety of processes and message flows. In particular implementations, some of the processes and message flows are directed to recording retrieval events in a manner that allows for content access tracking, conversion rate tracking, and allows one or more entities to share in the revenue generated by activation of the links. Example message and process flows involving activation of distribution links 501 have been described above. The following describes example process and message flows resulting from remote access to content objects, and activation of ad finks or controls.

For example, content marketplace system 30 may track content usage and provide reports to one or more entities, such as the content owner and the content embedding entity. For example, as to content hosted by it, content marketplace system 30 is naturally in a position to track content usage, since requests for the content are transmitted directly to it. In implementations discussed herein, content-embedding code may be configured to first direct messages to content marketplace system 30 which, redirects a client application to a remote content host. In this manner, content marketplace system 30 may track usage of remotely hosted content.

Content marketplace system 30 can track content object usage, which may be useful to generate reports, such as usage reports, revenue generation reports. For example, content marketplace system 30 may generate a content embedding report that allows content owners to view which content embedding entities have used their content. In addition, the content owners may view reports indicating the revenue attributable to given content objects and/or content embedding entities. Other reports may allow content embedding entities and sponsors to determine which content objects generate more revenue relative to other content objects.

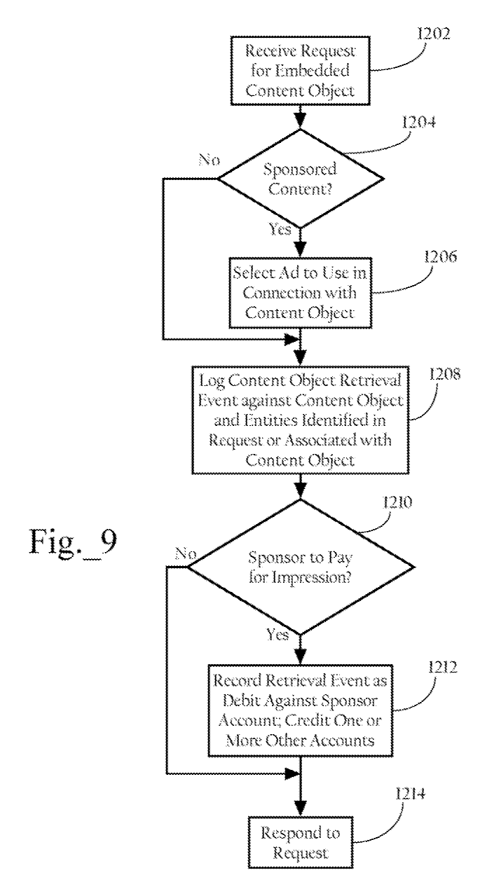

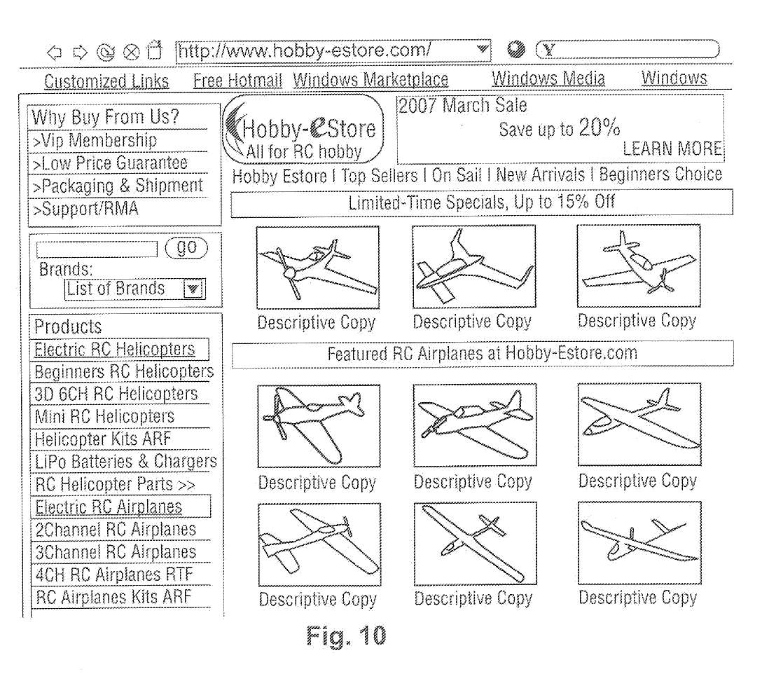

FIG. 9 illustrates an example method that may be implemented in response to a request for a content object transmitted to content marketplace system 30. A request for a content object may be transmitted by a browser client application in response to parsing an HTML page including an embedded reference to the content object, such as that illustrated in FIG. 6A. In other implementation, the request for a content object may be transmitted by a browser-plug-in or other client module (such as the Adobe Flash® media player) (see FIG. 6G). In the implementation shown, when server 32 receives a request for a content object (1202), it may access data store 34 to determine whether someone has sponsored the content object (1204). If so, content marketplace system 30 may access the sponsor account to select an ad to be used in connection with the digital content object (1206). Content marketplace system 30 may also log the request as a content object retrieval event against one or more entities identified in the request or the entities (e.g., content owner, content embedding entities, sponsor, etc.) associated with the content object (1208). For example, as FIGS. 6A and 6B illustrate, a content identifier 579 may be added as a parameter to the content URL, which is passed to content marketplace system 30 with the request for the content object. Content marketplace system 30 may use the content identifier to access one or more object instance records to ascertain the entities in the distribution chain. As discussed above, the content sponsor may have selected a pay-per-impression option. In the implementation shown, content marketplace system 30 may access a database, such as data store 34, to determine whether the content sponsor has selected this option (1210). If so, content marketplace system 30 records the retrieval event as a debit event against the account of the content owner (1212), and possibly a credit, against one or more other entitles, such as the content owner. In some implementations, content marketplace system 30 may also record the retrieval event as a credit against the account of one or more content embedding entities in the distribution chain, as defined by revenue sharing parameters specified by the content owner or uploader. Content marketplace system 30 then responds to the request. For example, if the content object is hosted locally, content marketplace system 30 responds with the digital content object. Furthermore, content marketplace system 30, if the content is hosted remotely, may generate a redirection message to the client application, as discussed above, causing it to access the content host system. Still further, in embodiments using a container format, such as Flash, the content marketplace may dynamically add the selected ad (and possibly other links or controls) to the underlying content object contained in the Flash or other container format object. In some embodiments, the Flash object, when executed, may make calls to obtain selected ads and the underlying digital content object, by accessing one or more variables in the content embedding code (see FIG. 6G). For example, the Flash object, when executed, may make a first call to obtain the content object, and a second call to obtain one or more selected ads (passing an identifier for the content object). The Flash object may than display the selected ad as a link, display it as an overlay, and/or display it proximal to the border of the viewer window or region where the content object is displayed or rendered. Similarly, audio or video players that are embedded or plug-in to the execution environment may include extended functionality to obtain and render selected ads.

FIG. 11 shows an example page that may be returned as a result of clicking on an advertisement link or other control. The URL of the page ultimately displayed to the user can be determined in a variety of ways. Clicking on the link that invoked the URL may generate revenue from the advertiser. This revenue may be generated by charging the content sponsor, and shared between one or more of the entities described herein. For example, the revenue generated from an ad link may be shared between content marketplace system, one or more content embedding entities in the distribution chain, the content owner, and/or the network application hosting entity. As discussed described herein, the message flows between the various systems can contain information, such as object instance identifiers and entity identifiers, to allow for determinations of the revenues or other benefits to be shared by various entities.

When a user “clicks” on the ad link or control with a computer input device, a request is transmitted to initiate retrieval of the information associated with the ad link. In some implementations, each access or “click” on the ad link will be directed to content marketplace system 30, or some other system, to associate the “click” with the account identifier for the sponsor. Content marketplace system 30 may access account identification information (or content object identification information) coded info the ad link before either accessing the ad of the sponsor, or transmitting a URL specified by the sponsor. The account identification information is recorded in the advertiser's account along with information from the retrieval request as a retrieval request event.

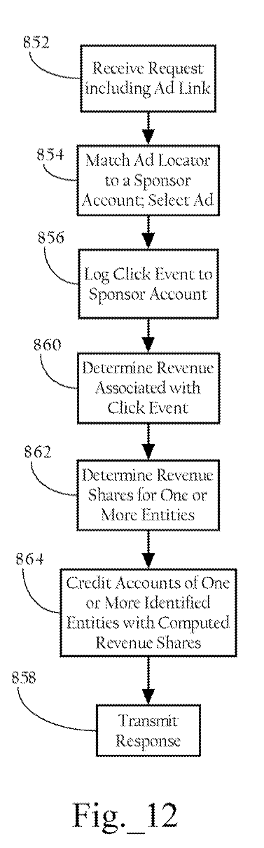

In the ad links illustrated in FIGS. 6A and 6C, content marketplace system 30 may process the ad links as illustrated in FIG. 12. For example, content marketplace system 30 may receive a request from a client application identifying an ad link (852). Content marketplace system 30 matches one or more aspects of the ad link to an advertiser account (854) by accessing information associated with the content object identifier to obtain (or select) a sponsor. As discussed above, content marketplace system 30 may access information regarding an auction process for the identified content object and select the current highest bidder. In another implementation, content marketplace system 30 may select a content sponsor from a pool of content sponsors according to a weighted round robin arbitration scheme, where the weighting correlates to bid amount. In such a scheme, content sponsors with, higher bids are selected more often. In other implementations, content marketplace system 30 may select the content sponsor with the highest bid and whose daily/weekly/monthly budget limit has not been exceeded. In yet other embodiments, content sponsors can pay for exclusive content sponsorship arrangements as to a given content object. Furthermore, after selection of a content sponsor, content marketplace system 30 may then select an ad from a set of ads associated with the content sponsor. Similarly, ad selection can be based on round robin arbitration, or random selection, schemes.

Content marketplace system 30 logs a click event to the identified sponsor account (856). Content marketplace system 30 may use these logs to debit or charge the account as well. Content marketplace system 30 determines the revenue (or other compensation) attributable to the retrieval event (860), and determines the share of the revenue provided to one or more of the entities identified in the ad link, or associated with the digital content object. As discussed above, content marketplace system 30, using the content identifier 579 in FIG. 6A (for example), can identify an object instance record (and possibly additional linked records) to identify a content owner and one or more content embedding entities. For example, content distribution system may access the object instance record corresponding to the content identifier 579 and traverse the linked chain of object instance records to identify all content embedding entities in the distribution chain and the original content uploader/uploader. As discussed above, revenue resulting from the user click may be shared between one or more of the content owner, the content embedding entities, the network application hosting entity, the content hosting entity, or the entity corresponding to the content marketplace system 30. In implementations where more than one entity is entitled to revenues, content marketplace system 30 determines the revenue shares of the one or more entities (862), and credits the respective accounts of the one more identified entities according to the computed revenue shares (864). As discussed above, one or more of the object instance records may include revenue sharing parameters that define how resulting revenue is shared between entities. Content marketplace system 30 also transmits a response to the request (858). In one implementation, the response can include a URL configured by the content sponsor in a redirection message. In other implementations, content marketplace system 30 can transmit actual ad creative content that has been uploaded to the sponsor's account. Other implementations are possible. For example, content marketplace system 30 can simply log the retrieval event and one or more entity identifiers for later batch processing.

Yet other implementations are possible. For example, the sponsor and selected ad can be identified during generation of the content embedding code and statically encoded into the content embedding code. In this implementation, the ad link, for example, may include a redirection URL that cause a client application to transmit a request to content marketplace system 30, which logs the ad request and transmit the sponsor URL in a redirection message to the client application.

The present invention has been explained with reference to specific embodiments. For example, while embodiments of the present invention have been described as operating in connection with HTML and HTTP, the present invention can be used in connection with any suitable protocol environment. Other embodiments will be evident to those of ordinary skill in the art. It is therefore not intended that the present invention be limited, except as indicated by the appended claims.

What is claimed is;

1. A method comprising:
receiving, from a remote host, a request for content-embedding code identifying a digital content object;
generating content-embedding code comprising machine-readable instructions operative, when executed, to cause a processor to:
access the digital content object;
render an ad in connection with the content object; and
present an activatable sponsor control, wherein the sponsor control, when activated, is operative to initiate a workflow with a remote system directed to sponsoring the digital content object; and
transmitting a response to the remote host, wherein the response includes the content-embedding code.

2. The method of claim 1 wherein the content-embedding code is further operable to, responsive to activation of the sponsor control, transmit a sponsor request to a remote host, the request identifying the content object.

3. The method of claim 1 wherein the content-embedding code is further operable to, responsive to activation of the sponsor control, display a point-of-presence sponsor interface facilitating initiation of the workflow.

4. The method of claim 1 further comprising
responsive to a request for the content object generated by the content embedding code executed on a remote host, selecting an ad corresponding to a sponsor of the content object, and
returning the ad, or a data locator for the ad, to the remote host.

5. The method of claim 1 wherein the ad, when activated, is operative to cause a remote system to generate a benefit to one or more entities associated with distribution of the digital content object.

6. The method of claim 5 wherein the benefit is a monetary award.

7. The method of claim 4 wherein the ad, when activated, is operative to cause a remote system to charge an account corresponding to the sponsor of the selected ad.

8. The method of claim 7 wherein the ad, when activated, is farther operative to generate a benefit to one or more entities associated with distribution of the digital content object.

9. The method of claim 1 wherein the content-embedding code is further operable to cause the one or more processors to access a code module operable to render the digital content object and the ad.

10. The method of claim 9 wherein the code module is a browser plug-in.

11. The method of claim 9 wherein the code module is a media player.

12. The method of claim 1 wherein the rendered ad is an advertisement hyperlink corresponding to a network addressable advertiser resource, wherein the advertisement hyperlink, when activated, is operative to cause the processor to access the network addressable advertiser resource.

13. The method of claim 12 wherein the content embedding code is further operative to cause the processor to render the content as clickable region, which, when clicked, is operative to cause the processor to access the network addressable advertiser resource.

14. The method of claim 1 wherein the content-embedding code is further operable to:
present a distribution hyperlink identifying a network addressable resource, wherein the hyperlink, when activated, is operative to cause the processor to transmit a second request for content embedding code identifying the digital content object.

15. The method of claim 1 further comprising
determining a user identifier associated with the request for content-embedding code; and
adding the user identifier to the content-embedding code.

16. The method of claim 14 further comprising
determining a user identifier associated with the request for content-embedding code; and
generating an object instance record and an object instance identifier for the object instance record, wherein the object instance record identifies the digital content object and includes the user identifier.

17. The method of claim 16 wherein the request for content-embedding code identifies a second object instance record; and wherein the generating step further comprises associating the object instance record to the second object instance record.

18. The method of claim 17 wherein the object instance identifier is encoded into the distribution hyperlink.

19. The method of claim 1 wherein the content-embedding code is further operative to cause the processor to display the content.

20. The method of claim 1 wherein the content-embedding code comprises HTML code.

21. The method of claim 14 wherein the content embedding code comprises a script operative to dynamically generate the distribution hyperlink.

22. An apparatus comprising
a memory;
one or more processors;
logic encoded in one or more tangible media for execution and when executed operable to cause the one or more processors to:
receive, from a remote host, a request for content-embedding code identifying a digital content object;
generate content-embedding code comprising machine-readable instructions operative, when executed, to cause a processor to:
access the content object; and
present a distribution hyperlink identifying a network addressable resource, wherein the hyperlink, when activated, is operative to cause the processor to transmit a second request for content embedding code identifying the digital content object; and
transmit a response to the remote host, wherein the response includes the content-embedding code.

23. A method comprising
receiving, from a remote host, a message including a content identifier corresponding to a digital content object;
accessing a sponsor database for information identifying a sponsor of the digital content object;
recording an event related to the message in a data store;
transmitting a response to the remote host, wherein the response causes the remote host to receive an ad selected by the sponsor; and
responsive to activation of the ad at the remote host, accessing a data store of object instance records using the content identifier to identify one or more accounts associated with distribution of the content object corresponding to the content identifier; and
associating a benefit to one or more of the identified accounts based on the event.

24. The method of claim 23 wherein the accessing step comprises identifying a plurality of content embedding entities in a chain of distribution corresponding to the digital content object.
